(19) United States
(12) Patent Application Publication
(10) Pub. No.: US 2025/0386036 A1
(43) Pub. Date: Dec. 18, 2025

(54) INFORMATION PROCESSING APPARATUS AND METHOD

(71) Applicant: Sony Group Corporation, Tokyo (JP)

(72) Inventors: Tomoya NAGANUMA, Kanagawa (JP); Koji YANO, Tokyo (JP); Satoru KUMA, Tokyo (JP); Ohji NAKAGAMI, Tokyo (JP)

(73) Assignee: Sony Group Corporation, Tokyo (JP)

(21) Appl. No.: 18/877,273

(22) PCT Filed: Jul. 10, 2023
(86) PCT No.: PCT/JP2023/025406

§ 371 Date: Dec. 20, 2024

(30) Foreign Application Priority Data
Jul. 28, 2022 (JP) 2022-120246

(51) Int. Cl. H04N 19/172; G06T 7/70; G06T 17/05; H04N 19/119; H04N 19/139; H04N 19/184

(52) U.S. Cl. CPC H04N 19/172; G06T 7/70; G06T 17/05; H04N 19/119; H04N 19/139; H04N 19/184

(57) ABSTRACT

There is provided information processing apparatus and method that enable lowering of encoding efficiency to be suppressed. A tiling direction of 3D map information indicating a distribution state of a peripheral object in a 3-dimensional space in a periphery of a reference object is set in accordance with a direction of a change of a relative position between the reference object and the peripheral object, a plurality of 2D images expressing the 3D map information are tiled on a surface perpendicular to the set tiling direction, to generate a 2-dimensional tiling image, and the tiling image is encoded. The present disclosure can be applied to, for example, an information processing apparatus, an electronic apparatus, an information processing method, a program, or the like.

### TECHNICAL FIELD

The present disclosure relates to information processing apparatus and method and more particularly relates to information processing apparatus and method that enable lowering of encoding efficiency to be suppressed.

### BACKGROUND ART

From the past, there has been a 3-dimensional occupancy grid map (3D Occupancy Grid map) obtained based on point cloud data expressing a 3-dimensional space (see, for example, Patent Literature 1). Further, there has also been a method of limiting a range of the 3D occupancy grid map to a periphery of a predetermined reference object (also referred to as egocentric 3D occupancy grid map).

Since an information amount of such a 3D occupancy grid map is large, encoding for storage and transmission is being demanded, for example. As a method therefor, for example, a method of converting a 3D occupancy grid map which is 3D information into 2D information (conversion into 2-dimensional information) and performing encoding using a 2D information encoding system is conceivable.

As the method of converting 3D information into 2-dimensional information, there has been a method called tiling in which 3D information is divided in a predetermined direction to generate 2-dimensional tiles, and each of the tiles is arranged on a 2-dimensional plane to generate 2D information (see, for example, Patent Literature 2).

### CITATION LIST

### Patent Literature

Patent Literature 1: Japanese Patent Application Laid-open No. 2021-071814
Patent Literature 2: US Patent Application Publication No. 2019/0051017A1

### DISCLOSURE OF INVENTION

### Technical Problem

In the case of the method described in Patent Literature 2, however, encoding efficiency is not taken into account, and a direction of dividing the 3D information (also referred to as tiling direction) has been fixed to one direction. Therefore, when this method is applied to the encoding of an egocentric 3D occupancy grid map, there has been a fear that the encoding efficiency will be lowered.

The present disclosure has been made in view of the circumstances as described above and aims at enabling lowering of the encoding efficiency to be suppressed.

### Solution to Problem

An information processing apparatus according to an aspect of the present technology is an information processing apparatus including: a tiling direction setting unit which sets a tiling direction of 3D map information indicating a distribution state of a peripheral object in a 3-dimensional space in a periphery of a reference object, in accordance with a direction of a change of a relative position between the reference object and the peripheral object; a tiling image generation unit which tiles a plurality of 2D images expressing the 3D map information on a surface perpendicular to the set tiling direction, to generate a 2-dimensional tiling image; and an encoding unit which encodes the tiling image.

An information processing method according to an aspect of the present technology is an information processing method including: setting a tiling direction of 3D map information indicating a distribution state of a peripheral object in a 3-dimensional space in a periphery of a reference object, in accordance with a direction of a change of a relative position between the reference object and the peripheral object; tiling a plurality of 2D images expressing the 3D map information on a surface perpendicular to the set tiling direction, to generate a 2-dimensional tiling image; and encoding the tiling image.

An information processing apparatus according to another aspect of the present technology is an information processing apparatus including: a decoding unit which decodes a bit stream and generates a 2-dimensional tiling image and tiling direction information; a tiling direction setting unit which sets a tiling direction on the basis of the tiling direction information; and a map reconstruction unit which applies the set tiling direction to reconstruct 3D map information from the tiling image, in which the 3D map information is 3-dimensional map information indicating a distribution state of a peripheral object in a 3-dimensional space in a periphery of a reference object, and the tiling image is information generated by tiling a plurality of 2D images expressing the 3D map information on a surface perpendicular to the tiling direction.

An information processing method according to another aspect of the present technology is an information processing method including: decoding a bit stream and generating a 2-dimensional tiling image and tiling direction information; setting a tiling direction on the basis of the tiling direction information; and applying the set tiling direction to reconstruct 3D map information from the tiling image, in which the 3D map information is 3-dimensional map information indicating a distribution state of a peripheral object in a 3-dimensional space in a periphery of a reference object, and the tiling image is information generated by tiling a plurality of 2D images expressing the 3D map information on a surface perpendicular to the tiling direction.

In the information processing apparatus and method according to the aspect of the present technology, a tiling direction of 3D map information indicating a distribution state of a peripheral object in a 3-dimensional space in a periphery of a reference object is set in accordance with a direction of a change of a relative position between the reference object and the peripheral object, a plurality of 2D images expressing the 3D map information are tiled on a surface perpendicular to the set tiling direction, to generate a 2-dimensional tiling image, and the tiling image is encoded.

In the information processing apparatus and method according to the another aspect of the present technology, a bit stream is decoded and a 2-dimensional tiling image and tiling direction information are generated, a tiling direction is set on the basis of the tiling direction information, and the set tiling direction is applied to reconstruct 3D map information from the tiling image.

### BRIEF DESCRIPTION OF DRAWINGS

FIG. 1 Diagrams explaining conversion of a 3D occupancy grid map into point clouds.

FIG. 2 A diagram explaining generation of the 3D occupancy grid map.

FIG. 3 A diagram explaining the generation of the 3D occupancy grid map.

FIG. 4 A diagram explaining the generation of the 3D occupancy grid map.

FIG. 5 A diagram explaining generation of an egocentric 3D occupancy grid map.

FIG. 6 A diagram illustrating an example of a tiling state.

FIG. 7 A diagram illustrating an example of a state of an inter-frame prediction.

FIG. 8 A diagram illustrating an example of the state of the inter-frame prediction.

FIG. 9 A diagram illustrating an example of a tiling direction control method.

FIG. 10 A diagram illustrating an example of the tiling direction.

FIG. 11 A diagram illustrating an example of a state of setting the tiling direction.

FIG. 12 A diagram illustrating an example of the state of setting the tiling direction.

FIG. 13 A diagram illustrating an example of the state of setting the tiling direction.

FIG. 14 A diagram illustrating an example of a tiling direction control timing.

FIG. 15 A diagram illustrating an example of the tiling direction control timing.

FIG. 16 A diagram illustrating a main configuration example of an information processing system.

FIG. 17 A block diagram illustrating a main configuration example of an encoding apparatus.

FIG. 18 A flowchart explaining an example of a flow of encoding processing.

FIG. 19 A flowchart explaining an example of the flow of the encoding processing.

FIG. 20 A block diagram illustrating a main configuration example of a decoding apparatus.

FIG. 21 A flowchart explaining an example of a flow of decoding processing.

FIG. 22 A flowchart explaining an example of the flow of the decoding processing.

FIG. 23 A diagram illustrating an example of a tiling image.

FIG. 24 A diagram illustrating an example of the tiling direction control method.

FIG. 25 A block diagram illustrating a main configuration example of the encoding apparatus.

FIG. 26 A flowchart explaining an example of the flow of the encoding processing.

FIG. 27 A flowchart explaining an example of the flow of the encoding processing.

FIG. 28 A block diagram illustrating a main configuration example of a computer.

### MODES FOR CARRYING OUT THE INVENTION

Hereinafter, modes for carrying out the present disclosure (hereinafter, will be referred to as embodiments) will be described. It should be noted that descriptions will be given in the following order.
1. Literatures that support technical contents and technical terms, etc.
2. 3D occupancy grid map
3. Control of tiling direction based on relative position change direction
4. Control of tiling direction based on processing target 2D frame
5. Notes

### 1. Literatures that Support Technical Contents and Technical Terms, Etc

The range disclosed in the present technology includes not only contents described in the embodiments but also contents described in the following non-patent literatures and the like that have already been known at the time of the application, contents of other literatures that are referenced in the following non-patent literatures, and the like.
Patent Literature 1: (described above)
Patent Literature 2: (described above)

In other words, the contents described in the patent literatures described above, the contents of other literatures that are referenced in the patent literatures described above, and the like also become grounds in determining supporting conditions.

### 2. 3D Occupancy Grid Map

### <3D Occupancy Grid Map>

Patent Literature 1 has disclosed a method of expressing point cloud data that expresses a 3-dimensional space as a 3-dimensional occupancy grid map (3D Occupancy Grid map) (see, for example, paragraph [0003] or [0073]).

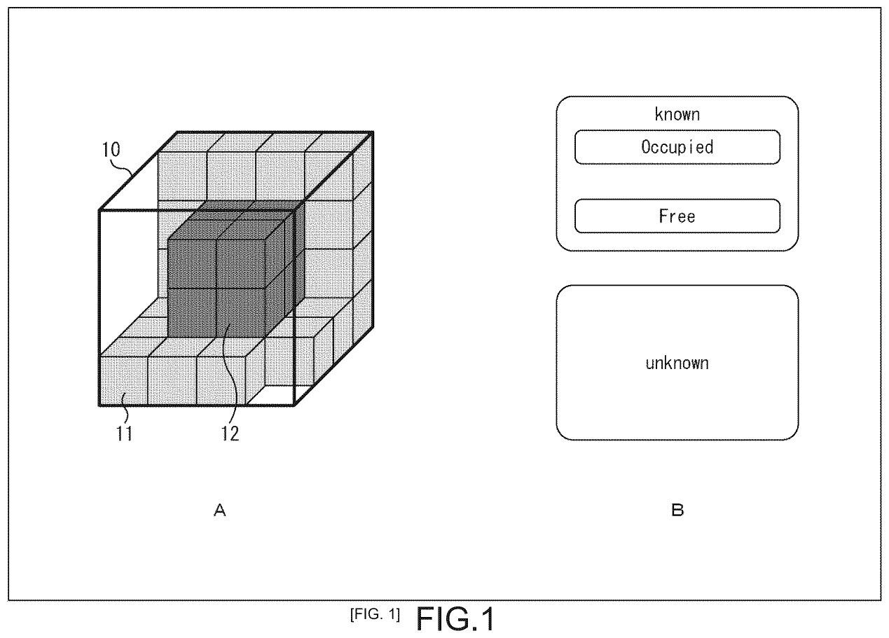

As shown in A of FIG. 1, for example, in the 3D occupancy grid map, a 3-dimensional space 10 is sectioned into predetermined grids, and an occupancy state (discrete occupancy state) is given to each grid. In other words, whether or not each grid has been observed (known/unknown) and whether or not each grid is occupied (Occupied/Free) are identified. The observed grid (known) is identified as Occupied 11 which is a grid occupied by an object or Free 12 which is a grid in which an object does not exist. In other words, each grid is identified as shown in B of FIG. 1.

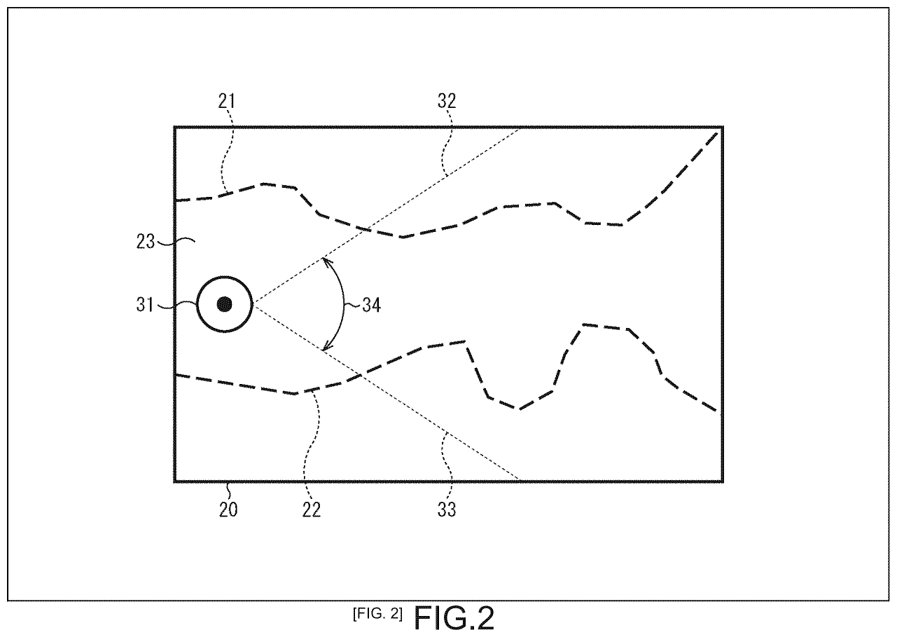

For example, it is assumed that as shown in FIG. 2, there is a space 23 sandwiched between a wall 21 and a wall 22 in an area 20. In the space 23, a robot 31 including a camera, a ranging sensor, and/or the like drives itself to generate a 3D occupancy grid map. It is assumed that the robot 31 has a measurable range 34 between a dotted line 32 and a dotted line 33.

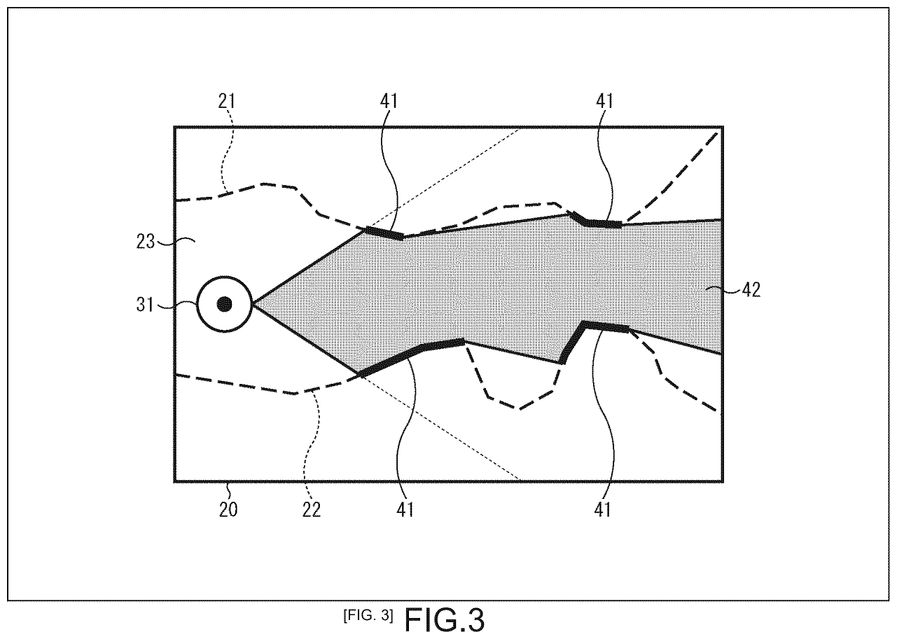

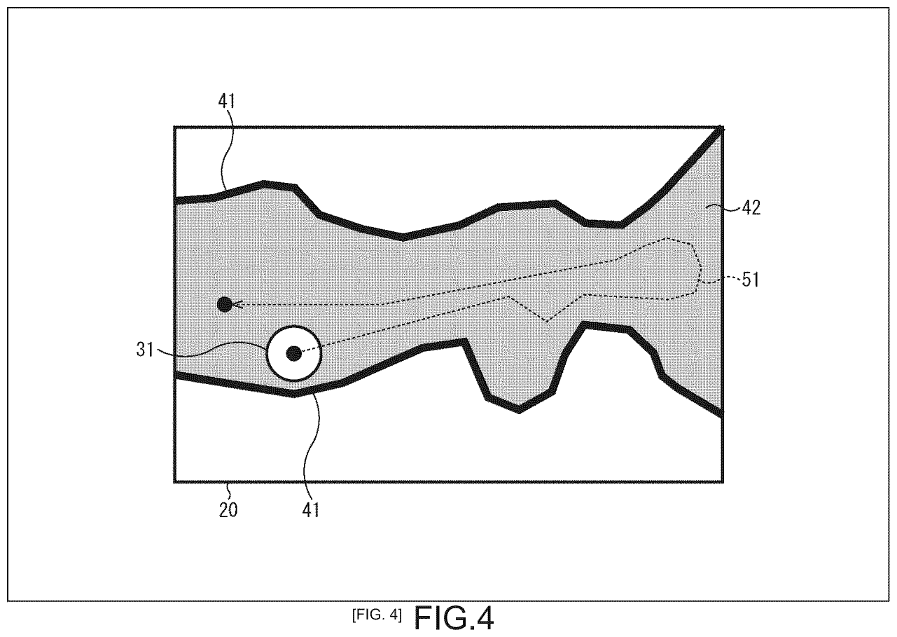

As shown in FIG. 3, the robot 31 identifies portions indicated by bold lines on the wall 21 and the wall 22 in the measurable range 34 as Occupied 41, and identifies an area of the space 23 illustrated in gray as Free 42. Other portions are identified as unknown. By driving itself, the robot 31 recognizes each of the wall 21 and the wall 22 as Occupied 41 and identifies the space 23 as Free 42 as shown in FIG. 4. In other words, in the case of this example, the wall 21 and the wall 22 are each recognized as an object.

In this manner, the 3D occupancy grid map is 3-dimensional map information indicating a distribution state of an object (a position and shape of an object) in a 3-dimensional space.

### <Egocentric 3D Occupancy Grid Map>

As one of the 3D occupancy grid maps, there has been a method of limiting a range of the map to a periphery of a predetermined reference object. Such a map is also referred to as an egocentric 3D occupancy grid map (Egocentric 3D Occupancy Grid Map). In other words, the egocentric 3D occupancy grid map is 3D map information indicating a distribution state of an object in a 3-dimensional space in a periphery of the reference object (a predetermined limited range that uses a position of the reference object as a reference) (also referred to as a peripheral object).

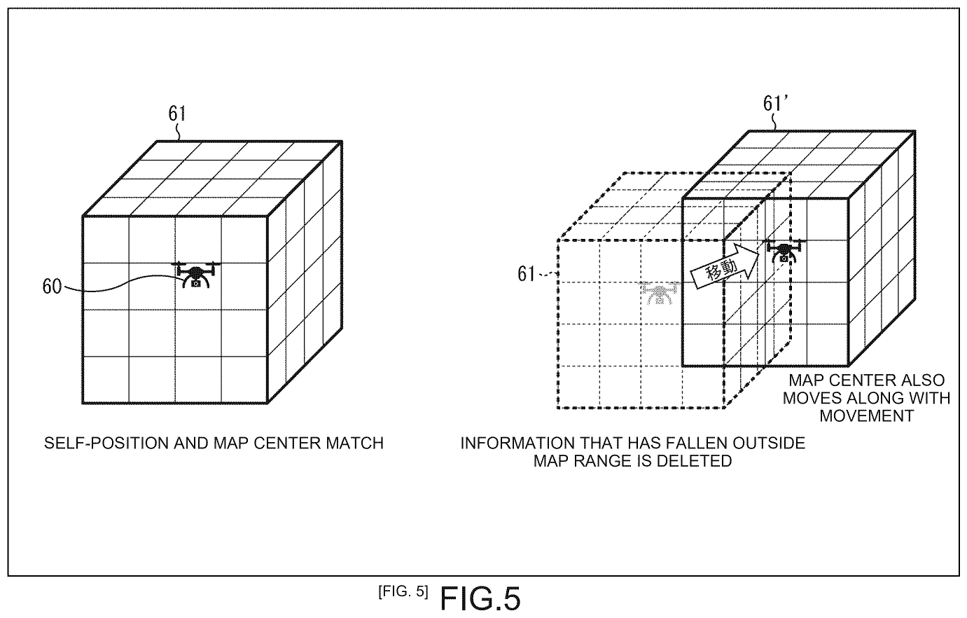

For example, an egocentric 3D occupancy grid map 61 shown on the left side of FIG. 5 is a 3D occupancy grid map of a predetermined limited range about a predetermined movable body 60. In other words, while the movable body 60 is set as the reference object, this egocentric 3D occupancy grid map 61 constantly indicates a distribution state of the object within a limited range about the movable body 60. Accordingly, when the movable body 60 moves as in the example shown on the right side of FIG. 5, the range indicated by the egocentric 3D occupancy grid map 61 also moves in accordance with that movement. In other words, information of the egocentric 3D occupancy grid map 61 is updated (egocentric 3D occupancy grid map 61′), and information that has fallen outside the map range by this movement is deleted.

For example, when the movable body 60 collects peripheral information while moving and generates a 3D occupancy grid map, there may be a case where it is difficult to unlimitedly retain the generated 3D occupancy grid map depending on a capacity of a memory provided in the movable body 60, or the like. In such a case, the movable body 60 can generate an egocentric 3D occupancy grid map 61 of a limited range about itself and successively transmit it to a server or the like, to suppress an increase of a necessary memory capacity.

Moreover, for example, when controlling the movement of the movable body 60 on the basis of the 3D occupancy grid map, or the like, there may be a case where it is only necessary to grasp a state of an object in the periphery of the movable body 60. Also in such a case, the egocentric 3D occupancy grid map can be applied to suppress an increase of a necessary memory capacity.

Further, also when the movable body 60 (reference object) does not move and a distribution state of a peripheral object is observed from a predetermined position, the movable body 60 can generate the egocentric 3D occupancy grid map 61 of a limited range about itself and successively transmit it to a server or the like, to suppress an increase of a necessary memory capacity.

In this manner, the egocentric 3D occupancy grid map is useful in various cases.

It should be noted that although the position of the reference object with respect to the range of the egocentric 3D occupancy grid map is arbitrary, the position of the reference object is set to be a center of the range of the egocentric 3D occupancy grid map in the present specification unless particularly stated otherwise. In addition, although a coordinate system used in the egocentric 3D occupancy grid map is arbitrary, an xyz coordinate system is used in the present specification unless particularly stated otherwise. Furthermore, although a shape of the range of the egocentric 3D occupancy grid map is arbitrary, a rectangle having sides in respective axial directions of the xyz coordinate system is used in the present specification unless particularly stated otherwise.

Further, the egocentric 3D occupancy grid map may change in time series like a two-dimensional moving image. In other words, it is assumed that the egocentric 3D occupancy grid map has a frame structure similar to that of a moving image (a data structure in which pieces of data of respective clock times are arranged as frames in a time direction). Intervals of the frames may be irregular, but is periodic (predetermined time intervals) in the present specification unless particularly stated otherwise.

Further, the reference object only needs to be an object that can be used as a reference for the range of the egocentric 3D occupancy grid map, and may generate the egocentric 3D occupancy grid map, or does not need to generate the egocentric 3D occupancy grid map. Furthermore, the reference object may be a movable body that is capable of moving, or may be a fixed body that is fixedly installed.

### <Encoding>

Even with the limited range, the egocentric 3D occupancy grid map has a large information amount since it has information for each grid of the 3-dimensional space. In this regard, encoding of the egocentric 3D occupancy grid map is being demanded for a reduction of an occupancy bandwidth used for transmission and/or for a reduction of a necessary storage capacity used for storage.

A method of encoding an egocentric 3D occupancy grid map as 3D information using a 3D information encoding system is also conceivable, but a 2D information encoding system is more generalized. In this regard, for example, a method of converting an egocentric 3D occupancy grid map which is 3D information into 2D information (conversion into 2-dimensional information) and encoding the information using a moving image encoding system (e.g., AVC (Advanced Video Coding), HEVC (High Efficiency Video Coding), VVC (Versatile Video Coding), or the like) is conceivable. With such a method, encoding/decoding can be performed using a more generalized codec and thus can be realized more inexpensively.

### <Tiling>

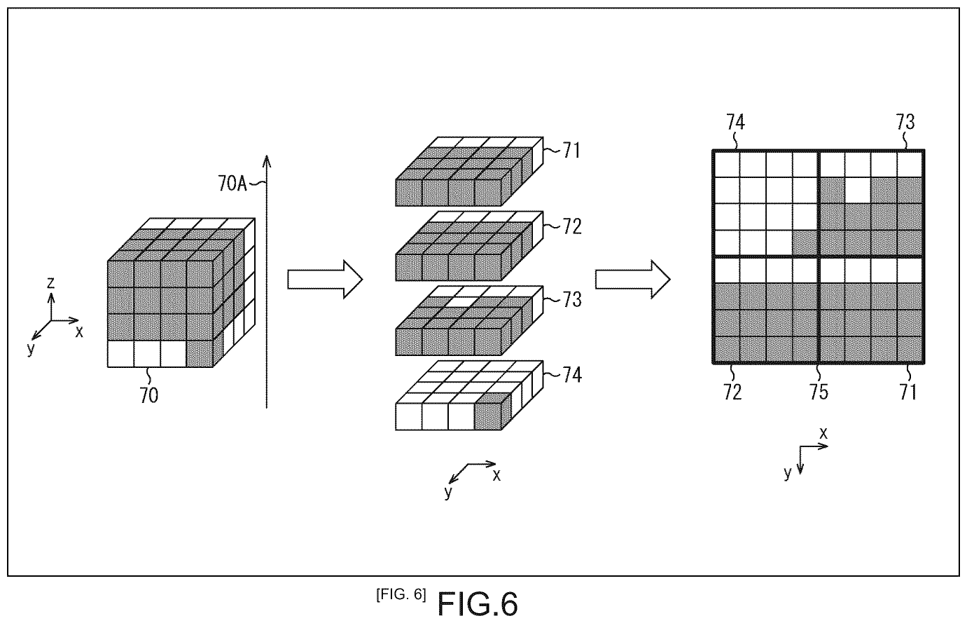

The method called tiling has been disclosed in Patent Literature 2 as the method of converting 3D information into 2-dimensional information. In the tiling, 3D information is divided in a predetermined direction to generate 2-dimensional tiles, and each of the tiles is arranged on a 2-dimensional plane, to generate 2D information. For example, as shown in FIG. 6, an egocentric 3D occupancy grid map 70 having 4×4×4 grids is divided in a z-axis direction (arrow 70A) for each grid, and four tiles each having 4×4 grids on an xy plane are generated (tiles 71 to 74). Then, the four tiles are arranged 2×2 on a plane so that a 2-dimensional tiling image 75 is generated. In this manner, the tiling enables 3D information to be converted into 2D information by an easy method. It should be noted that the direction of dividing 3D information in the tiling (the direction of the arrow 70A in the case of the example shown in FIG. 6) will be referred to as a tiling direction.

By generating a tiling image in this manner for data of each frame, the moving image encoding system becomes applicable, and thus the egocentric 3D occupancy grid map can be encoded and decoded more inexpensively.

<Encoding of tiling image>

In the case of the method described in Patent Literature 2, however, the tiling direction has been fixed to one direction. Therefore, when this method is applied to the encoding of an egocentric 3D occupancy grid map, there has been a fear that the encoding efficiency will be lowered.

For example, by tiling an egocentric 3D occupancy grid map to generate a tiling image and encoding the tiling image by the moving image encoding system as described above, inter-frame difference encoding can be applied. The inter-frame difference encoding is a method of obtaining a data difference between frames and encoding the difference.

A change of a content of the egocentric 3D occupancy grid map in a time direction means a movement of the reference object or a movement of the peripheral object (including deformation). In other words, the change of (the content of) the egocentric 3D occupancy grid map in the time direction indicates a change of a relative position between the reference object and the peripheral object. This change amount can be extracted and encoded by the inter-frame prediction described above. Accordingly, an information amount to be encoded can be reduced, and the encoding efficiency can be improved.

The following three methods are conceivable as this inter-frame difference encoding method. The first method is a method of simply obtaining a difference between entire frames and encoding the difference (also referred to as simple difference). The second method is a method of obtaining a difference between entire frames after correcting a movement amount between the frames (a deviation of the entire frame), and encoding the difference (also referred to as correction difference). The third method is inter-prediction (a method of estimating each of local motion vectors to generate a prediction image, and obtaining and encoding a prediction residual) that is performed in the moving image encoding system of AVC, HEVC, VVC, and the like.

However, there has been a fear that, when the relative position between the reference object and the peripheral object changes in the tiling direction, a correlation between the frames (i.e., prediction accuracy) will be lowered to thus lower the encoding efficiency in any of the methods for the inter-frame difference encoding.

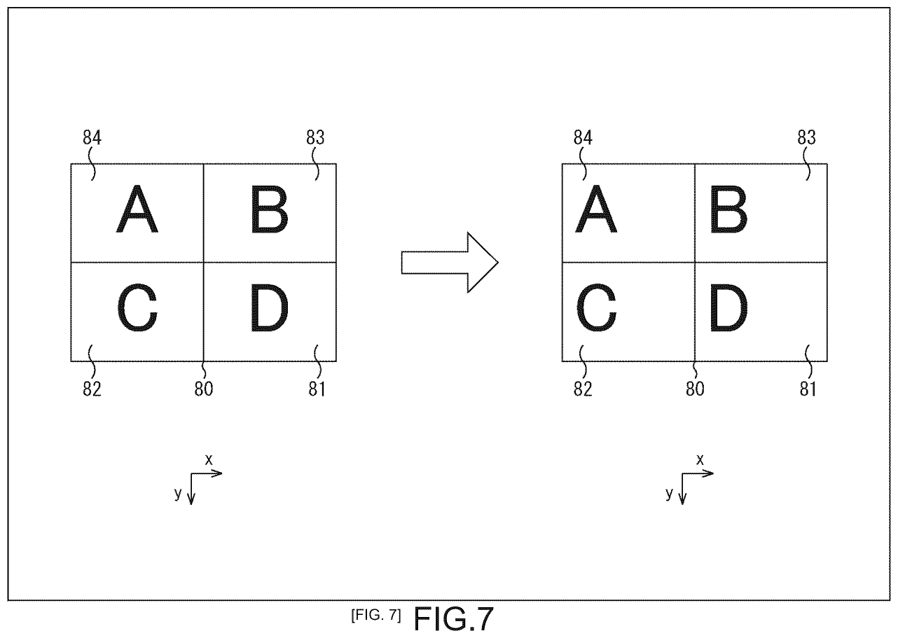

FIG. 7 illustrates an example of a state of a change of a tiling image in a case where the relative position between the reference object and the peripheral object changes in a direction perpendicular to the tiling direction (a planar direction of the tiling image). FIG. 7 schematically (as letters) shows the distribution state of an object for explanation. In other words, differences in the letters indicate differences in the distribution state of the object.

In FIG. 7, a tiling image 80 is image information in which tiles 81 to 84 are arranged to be 2×2. In the first state, as shown on the left side of FIG. 7, a letter “D” is displayed at the center of the tile 81, a letter “C” is displayed at the center of the tile 82, a letter “B” is displayed at the center of the tile 83, and a letter “A” is displayed at the center of the tile 84. When the relative position between the reference object and the peripheral object changes in the direction perpendicular to the tiling direction (deviates in a leftward direction in the figure), the letter deviates in the leftward direction in each of the tiles as shown on the right side of FIG. 7. In other words, since the entire tiling image 80 merely deviates in the leftward direction, the correlation between the frames is high. Accordingly, in this case, in any of the methods for the inter-frame difference encoding described above, the prediction accuracy is high, and encoding can be performed with high encoding efficiency.

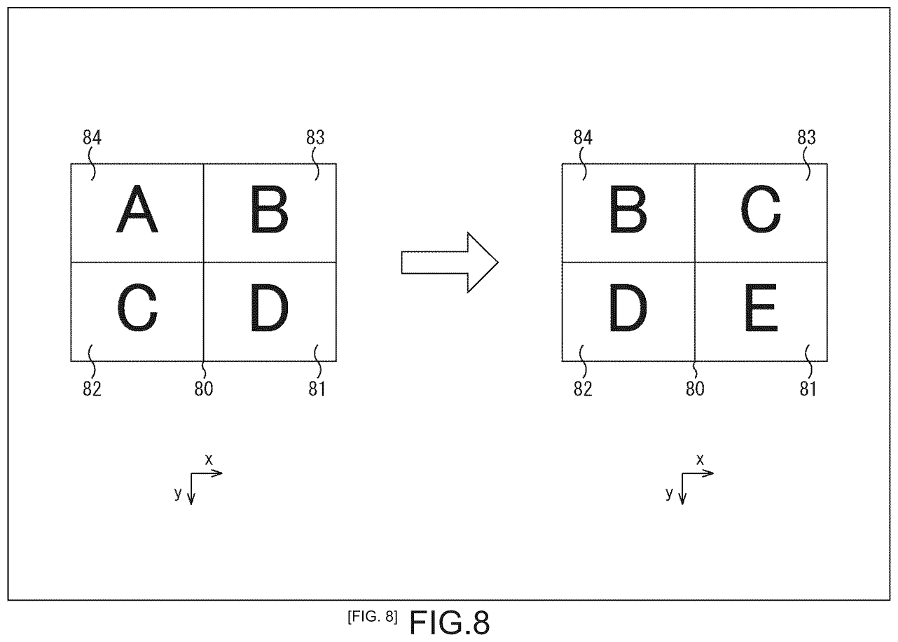

In contrast, when the relative position between the reference object and the peripheral object changes in the tiling direction, the tiling image 80 changes from the state shown on the left side to the state shown on the right side of FIG. 8. FIG. 8 also schematically (as letters) shows the distribution state of the object for explanation. In other words, differences in the letters indicate differences in the distribution state of the object.

Specifically, the letter A is changed to the letter B in the object distribution of the tile 84, the letter B is changed to the letter C in the object distribution of the tile 83, the letter C is changed to the letter D in the object distribution of the tile 82, and the letter D is changed to a letter E in the object distribution of the tile 81. In other words, the object distribution indicated by the letter A is eliminated, the object distributions respectively indicated by the letters B to D are moved to the different tiles, and an object distribution indicated by the letter E is newly added.

Accordingly, in the case of the simple difference, for example, since the movements of the letters are large and movement directions are not unified, the correlation between the frames at the respective positions is lower than that of the case shown in FIG. 7. Therefore, there has been a fear that the encoding efficiency will be lowered. In addition, in the case of the inter-prediction, since the movement amounts of the letters B to D are larger than those of FIG. 7, motion vectors become large. Furthermore, since the letter A is eliminated and the letter E is added, the correlation between the frames is low at these portions. Therefore, there has been a fear that the encoding efficiency will be lowered. Moreover, in the case of the correction difference, while the positions (tiles) of the letters B to D can be matched, the letter E at the timing shown on the left side of FIG. 8 (or the letter A at the timing shown on the right side of FIG. 8) cannot be obtained, so the difference becomes larger than that of the case shown in FIG. 7 (the correlation between the frames is low). Therefore, there has been a fear that the encoding efficiency will be lowered.

### 3. Control of Tiling Direction Based on Relative Position Change Direction

### Method 1

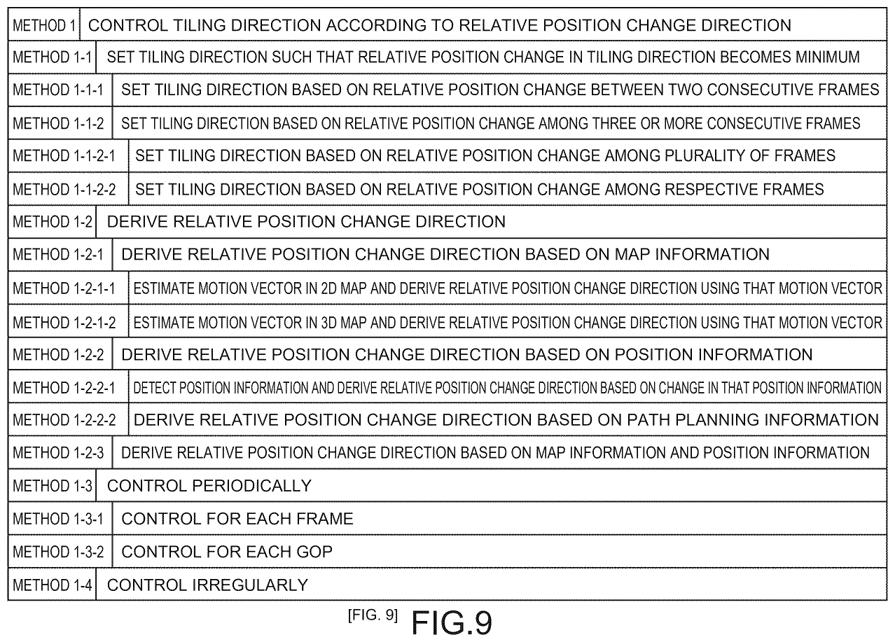

In this regard, the tiling direction is controlled according to a relative position change direction as indicated on the top row of the table shown in FIG. 9 (Method 1).

For example, an information processing apparatus includes: a tiling direction setting unit which sets a tiling direction of 3D map information (egocentric 3D occupancy grid map) indicating a distribution state of a peripheral object in a 3-dimensional space in a periphery of a reference object, in accordance with a direction of a change of a relative position between the reference object and the peripheral object; a tiling image generation unit which tiles a plurality of 2D images (the tiles 71 to 74 in the case of the example shown in FIG. 6) expressing the 3D map information on a surface perpendicular to the set tiling direction (the z direction in the case of the example shown in FIG. 6) (the xy plane in the case of the example shown in FIG. 6), to generate a 2-dimensional tiling image (the tiling image 75 in the case of the example shown in FIG. 6); and an encoding unit which encodes the tiling image.

For example, an information processing method includes: setting a tiling direction of 3D map information (egocentric 3D occupancy grid map) indicating a distribution state of a peripheral object in a 3-dimensional space in a periphery of a reference object, in accordance with a direction of a change of a relative position between the reference object and the peripheral object; tiling a plurality of 2D images expressing the 3D map information on a surface perpendicular to the set tiling direction, to generate a 2-dimensional tiling image; and encoding the tiling image.

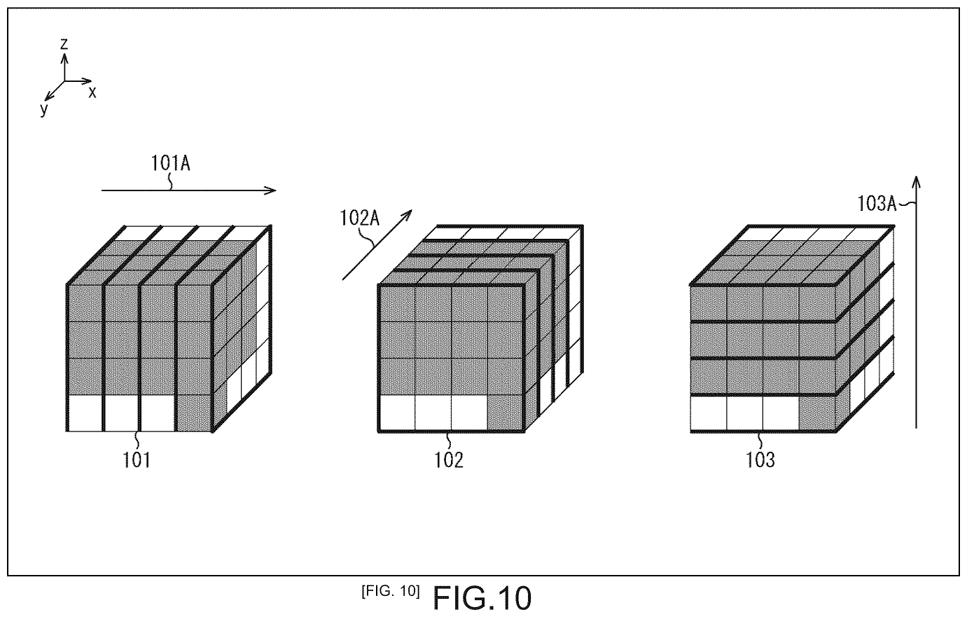

In FIG. 10, an egocentric 3D occupancy grid map 101 shows a state where the egocentric 3D occupancy grid map 70 shown in FIG. 6 is tiled while an x-axis direction (a direction indicated by an arrow 101A) is set as the tiling direction. Bold lines in the egocentric 3D occupancy grid map 101 indicate positions to be divided. An egocentric 3D occupancy grid map 102 shows a state where the egocentric 3D occupancy grid map 70 is tiled while a y-axis direction (a direction indicated by an arrow 102A) is set as the tiling direction. Bold lines in the egocentric 3D occupancy grid map 102 indicate positions to be divided. An egocentric 3D occupancy grid map 103 shows a state where the egocentric 3D occupancy grid map 70 shown in FIG. 6 is tiled while the z-axis direction (a direction indicated by an arrow 103A) is set as the tiling direction. Bold lines in the egocentric 3D occupancy grid map 103 indicate positions to be divided.

In this manner, there are a plurality of directions that can be set as the tiling direction with respect to the egocentric 3D occupancy grid map. For example, with these tiling directions as candidates, one of these is selected (set) according to the relative position change direction.

With such a configuration, it is possible to suppress lowering of the correlation between the frames as described above and suppress lowering of the encoding efficiency in the inter-frame difference encoding. Accordingly, lowering of the encoding efficiency in the encoding of the egocentric 3D occupancy grid map can be suppressed.

It should be noted that the tiling direction can be set to an arbitrary direction, but is set to any of the x-axis direction, the y-axis direction, or the z-axis direction (i.e., any of the axial directions of the coordinate system) in the present specification unless particularly stated otherwise.

It should be noted that in the information processing apparatus including the tiling direction setting unit, the tiling image generation unit, and the encoding unit, the tiling direction setting unit may generate tiling direction information indicating the set tiling direction, and the encoding unit may encode the tiling direction information. With such a configuration, the information processing apparatus that decodes encoded data of a tiling image can easily grasp the tiling direction on the basis of the tiling direction information. In other words, the information processing apparatus can more easily and correctly reconstruct the egocentric 3D occupancy grid map.

For example, an information processing apparatus includes: a decoding unit which decodes a bit stream and generates a 2-dimensional tiling image and tiling direction information; a tiling direction setting unit which sets a tiling direction on the basis of the tiling direction information; and a map reconstruction unit which applies the set tiling direction to reconstruct 3D map information (egocentric 3D occupancy grid map) from the tiling image. It should be noted that the 3D map information is 3-dimensional map information indicating a distribution state of a peripheral object in a 3-dimensional space in a periphery of a reference object. In addition, the tiling image (the tiling image 75 in the case of the example shown in FIG. 6) is information generated by tiling a plurality of 2D images (the tiles 71 to 74 in the case of the example shown in FIG. 6) expressing the 3D map information on a surface perpendicular to the tiling direction (the z direction in the case of the example shown in FIG. 6) (the xy plane in the case of the example shown in FIG. 6).

For example, an information processing method includes: decoding a bit stream and generating a 2-dimensional tiling image and tiling direction information; setting a tiling direction on the basis of the tiling direction information; and applying the set tiling direction to reconstruct 3D map information (egocentric 3D occupancy grid map) from the tiling image. It should be noted that the 3D map information is 3-dimensional map information indicating a distribution state of a peripheral object in a 3-dimensional space in a periphery of a reference object. In addition, the tiling image is information generated by tiling a plurality of 2D images expressing the 3D map information on a surface perpendicular to the tiling direction.

With such a configuration, the egocentric 3D occupancy grid map can be correctly reconstructed with ease. Accordingly, lowering of the encoding efficiency in the encoding of the egocentric 3D occupancy grid map can be suppressed.

### Method 1-1

When this Method 1 is applied, the tiling direction may be set such that the relative position change in the tiling direction becomes minimum as indicated on the second row from the top of the table shown in FIG. 9 (Method 1-1).

For example, in the information processing apparatus including the tiling direction setting unit, the tiling image generation unit, and the encoding unit, the tiling direction setting unit may set the tiling direction such that a change amount of the relative position between the reference object and the peripheral object in the tiling direction becomes minimum. In other words, the tiling direction setting unit may set the tiling direction such that a component of the tiling direction in the change of the relative position between the reference object and the peripheral object becomes minimum. That is, in this case, the tiling direction setting unit sets the tiling direction such that the change described with reference to FIG. 8 becomes minimum.

With such a configuration, it is possible to suppress lowering of the correlation between the frames as described above and suppress lowering of the encoding efficiency in the inter-frame difference encoding. Accordingly, lowering of the encoding efficiency in the encoding of the egocentric 3D occupancy grid map can be suppressed.

### Method 1-1-1

When this Method 1-1 is applied, the tiling direction may be set on the basis of the change of the relative position between two consecutive frames as indicated on the third row from the top of the table shown in FIG. 9 (Method 1-1-1). For example, the tiling direction may be set on the basis of the change of the relative position between the current frame and a frame that is one frame before that.

For example, in the information processing apparatus including the tiling direction setting unit, the tiling image generation unit, and the encoding unit, the tiling direction setting unit may set the tiling direction on the basis of the change of the relative position between the reference object and the peripheral object between two consecutive frames.

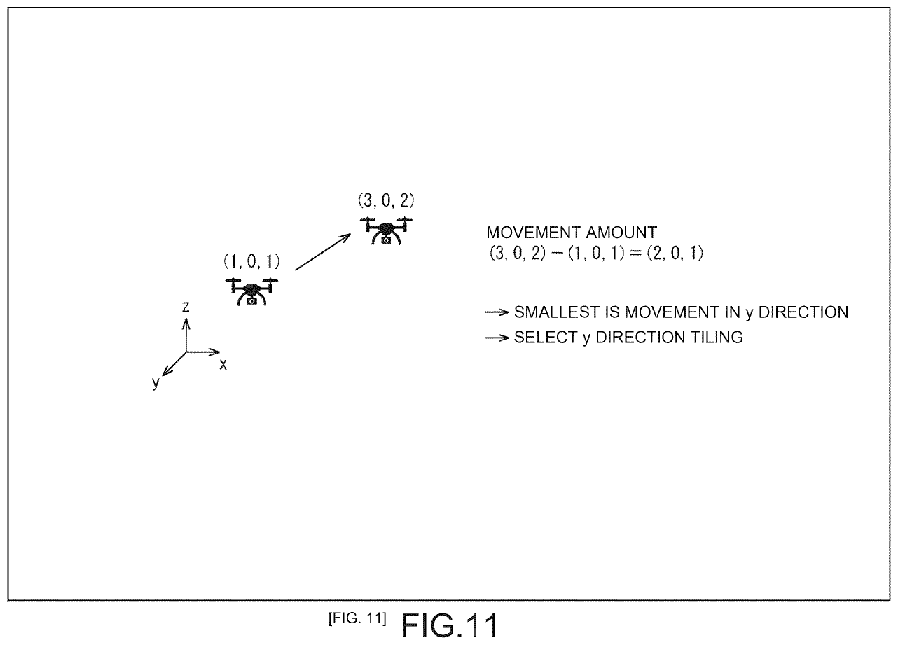

For example, as shown in FIG. 11, it is assumed that the position of the reference object (x, y, z) is (1, 0, 1) in the frame that is one frame before the current frame and is (3, 0, 2) in the current frame. In addition, it is assumed that the position of the peripheral object does not change (is fixed) during that period. When this Method 1-1-1 is applied, the tiling direction setting unit sets the movement amount of the reference object as a positional difference (3, 0, 2)−(1, 0, 1)=(2, 0, 1) between the two frames. In other words, in this case, the movement amount in the y-axis direction is the smallest. Accordingly, the tiling direction setting unit sets the tiling direction to the y-axis direction. In other words, the tiling is performed while the y-axis direction is set as the tiling direction.

With such a configuration, it is possible to suppress lowering of the correlation between the two frames and suppress lowering of the encoding efficiency in the inter-frame difference encoding. Accordingly, lowering of the encoding efficiency in the encoding of the egocentric 3D occupancy grid map can be suppressed. For example, by setting the tiling direction on the basis of the change of the relative position between the two latest frames (the current frame and the frame that is one frame before that), the tiling direction can be controlled more promptly with respect to the change of the relative position.

### Method 1-1-2

Further, when Method 1-1 is applied, the tiling direction may be set on the basis of the change of the relative position among three or more consecutive frames as indicated on the fourth row from the top of the table shown in FIG. 9 (Method 1-1-2). For example, the tiling direction may be set on the basis of the change of the relative position in a section from the current frame to a frame that is two or more frames before the current frame. It should be noted that a length of this section may be any number of frames as long as it is 3 or more frames.

For example, in the information processing apparatus including the tiling direction setting unit, the tiling image generation unit, and the encoding unit, the tiling direction setting unit may set the tiling direction on the basis of the change of the relative position between the reference object and the peripheral object in a section of three or more consecutive frames.

With such a configuration, it is possible to suppress lowering of the correlation in the section of three or more frames and suppress lowering of the encoding efficiency in the inter-frame difference encoding. Accordingly, lowering of the encoding efficiency in the encoding of the egocentric 3D occupancy grid map can be suppressed. By setting the tiling direction on the basis of the change of the relative position in a section of a longer period, the tiling direction can be controlled according to the change of the relative position of a longer period. Thus, the tiling direction can be controlled more stably.

### Method 1-1-2-1

Further, when Method 1-1-2 is applied, the tiling direction may be set on the basis of the change of the relative position among a plurality of frames as indicated on the fifth row from the top of the table shown in FIG. 9 (Method 1-1-2-1). In other words, the tiling direction may be set on the basis of the change of the relative position between a head frame and a last frame in the section of 3 or more frames.

For example, in the information processing apparatus including the tiling direction setting unit, the tiling image generation unit, and the encoding unit, the tiling direction setting unit may set the tiling direction on the basis of the change of the relative position between the reference object and the peripheral object between a head frame and a last frame in the section of three or more consecutive frames.

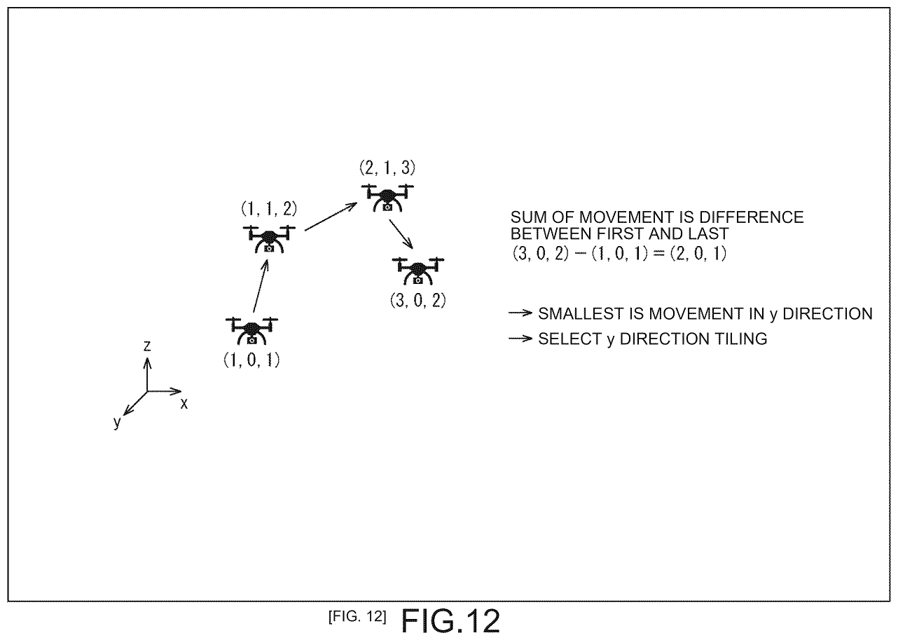

For example, as shown in FIG. 12, it is assumed that the position of the reference object (x, y, z) has changed from (1, 0, 1)→(1, 1, 2)→(2, 1, 3)→(3, 0, 2) in a section of four frames. In addition, it is assumed that the position of the peripheral object does not change (is fixed) during that period. When this Method 1-1-2-1 is applied, the tiling direction setting unit sets the movement amount of the reference object as a positional difference (3, 0, 2)−(1, 0, 1)=(2, 0, 1) between the head frame and the last frame in this section. In other words, in this case, the movement amount in the y-axis direction is the smallest. Accordingly, the tiling direction setting unit sets the tiling direction to the y-axis direction. In other words, the tiling is performed while the y-axis direction is set as the tiling direction.

With such a configuration, it is possible to suppress lowering of the correlation in the section of three or more frames and suppress lowering of the encoding efficiency in the inter-frame difference encoding. Accordingly, lowering of the encoding efficiency in the encoding of the egocentric 3D occupancy grid map can be suppressed. By setting the length of this section to become longer, the tiling direction can be controlled according to the change of the relative position of a longer period. In other words, it is possible suppress an effect of more-minute changes of the relative position and control the tiling direction more stably.

### Method 1-1-2-2

Further, when Method 1-1-2 is applied, the tiling direction may be set on the basis of the change of the relative position between respective frames as indicated on the sixth row from the top of the table shown in FIG. 9 (Method 1-1-2-2). For example, a temporary tiling direction may be obtained such that the change of the relative position in the tiling direction becomes minimum between the respective frames in the section of three or more frames, and a direction most-frequently selected as the temporary tiling direction in the section may be set as the tiling direction to be applied.

For example, in the information processing apparatus including the tiling direction setting unit, the tiling image generation unit, and the encoding unit, the tiling direction setting unit may set the tiling direction on the basis of the change of the relative position between the reference object and the peripheral object between respective frames in the section of three or more consecutive frames.

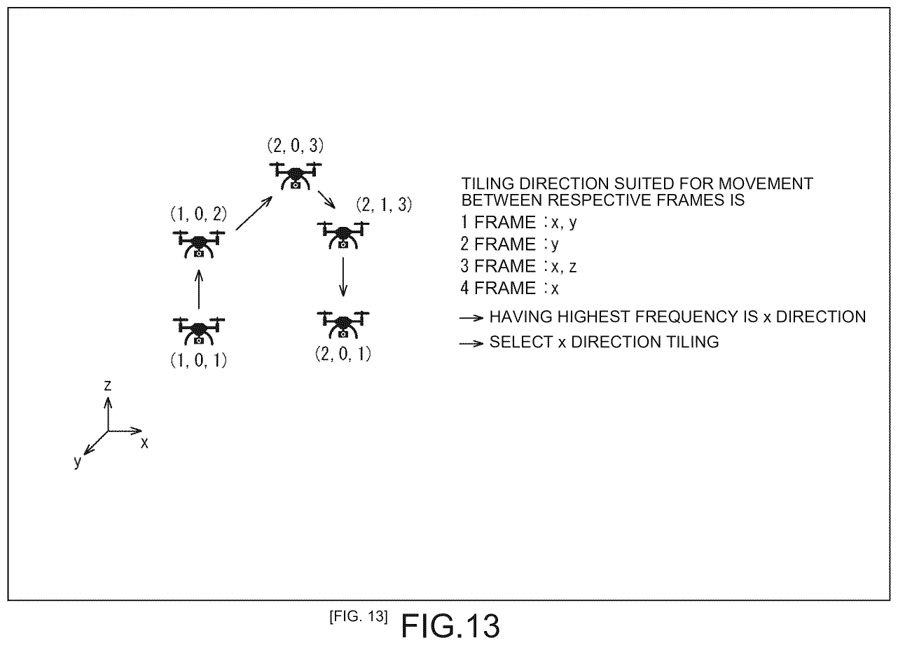

For example, as shown in FIG. 13, it is assumed that the position of the reference object (x, y, z) has changed from (1, 0, 1)→(1, 0, 2)→(2, 0, 3)→(2, 1, 3)→(2, 0, 1) in a section of five frames. In addition, it is assumed that the position of the peripheral object does not change (is fixed) during that period. When this Method 1-1-2-2 is applied, the tiling direction setting unit obtains a temporary tiling direction such that the change of the relative position in the tiling direction becomes minimum between the respective frames. A difference between the position in the head frame and the position in the second frame is (1, 0, 2)−(1, 0, 1)=(0, 0, 1). Accordingly, the tiling direction suited for this change of the relative position between the frames (temporary tiling direction) is the x-axis direction and the y-axis direction. Moreover, a difference between the position in the second frame and the position in the third frame is (2, 0, 3)−(1, 0, 2)=(1, 0, 1). Accordingly, the tiling direction suited for this change of the relative position between the frames (temporary tiling direction) is the y-axis direction. A difference between the position in the third frame and the position in the fourth frame is (2, 1, 3)−(2, 0, 3)=(0, 1, 0). Accordingly, the tiling direction suited for this change of the relative position between the frames (temporary tiling direction) is the x-axis direction and the z-axis direction. A difference between the position in the fourth frame and the position in the fifth frame is (2, 0, 1)−(2, 1, 3)=(0, −1, −2). Accordingly, the tiling direction suited for this change of the relative position between the frames (temporary tiling direction) is the x-axis direction.

In other words, the direction most-frequently selected as the temporary tiling direction in this section is the x-axis direction. Accordingly, the tiling direction setting unit sets the tiling direction to the x-axis direction. In other words, the tiling is performed while the x-axis direction is set as the tiling direction.

With such a configuration, it is possible to suppress lowering of the correlation in the section of three or more frames and suppress lowering of the encoding efficiency in the inter-frame difference encoding. Accordingly, lowering of the encoding efficiency in the encoding of the egocentric 3D occupancy grid map can be suppressed. By setting the length of this section to become longer, the tiling direction can be controlled according to the change of a longer period without eliminating the effect of more-minute changes of the relative position. In other words, the tiling direction can be controlled in accordance with more various changes of the relative position.

### Method 1-2

Further, when Method 1 is applied, a relative position change direction may be derived as indicated on the seventh row from the top of the table shown in FIG. 9 (Method 1-2).

For example, the information processing apparatus including the tiling direction setting unit, the tiling image generation unit, and the encoding unit may further include a relative position change direction derivation unit which derives the direction of the change of the relative position between the reference object and the peripheral object, and the tiling direction setting unit may set the tiling direction in accordance with the derived direction of the change of the relative position. In other words, the direction of the change of the relative position used for setting the tiling direction may be acquired from others, but may alternatively be derived in the information processing apparatus.

With such a configuration, the information processing apparatus can set the tiling direction while deriving the direction of the change of the relative position between the reference object and the peripheral object.

### Method 1-2-1

The direction of the change of the relative position may be derived on the basis of arbitrary information. For example, the direction of the change of the relative position may be derived on the basis of the egocentric 3D occupancy grid map as the encoding target. In other words, when Method 1-2 is applied, the direction of the change of the relative position may be derived on the basis of 3D map information (egocentric 3D occupancy grid map) as indicated on the eighth row from the top of the table shown in FIG. 9 (Method 1-2-1).

For example, in the information processing apparatus including the tiling direction setting unit, the tiling image generation unit, the encoding unit, and the relative position change direction derivation unit, the relative position change direction derivation unit may derive the direction of the change of the relative position between the reference object and the peripheral object on the basis of the 3D map information.

As described above, the change of (the content of) the egocentric 3D occupancy grid map in the time direction indicates the change of the relative position between the reference object and the peripheral object. In other words, the direction of the change of the relative position between the reference object and the peripheral object can be derived from the egocentric 3D occupancy grid map. In this case, the direction of the change of the relative position can be derived while taking into account not only the movement of the reference object but also the movement of the peripheral object. In other words, by this method, for example, the direction of the change of the relative position can be correctly derived also when the position of the reference object is fixed and the position of the peripheral object changes or also when the positions of the reference object and the peripheral object change.

### Method 1-2-1-1

The method of deriving the direction of the change of the relative position from the egocentric 3D occupancy grid map is arbitrary. For example, the direction of the change of the relative position may be derived on the basis of an egocentric 3D occupancy grid map converted into 2-dimensional information (i.e., tiling image). In other words, when Method 1-2-1 is applied, a motion vector may be estimated from 2D map information (i.e., tiling image), and the relative position change direction may be derived using the motion vector as indicated on the ninth row from the top of the table shown in FIG. 9 (Method 1-2-1-1).

For example, in the information processing apparatus including the tiling direction setting unit, the tiling image generation unit, the encoding unit, and the relative position change direction derivation unit, the relative position change direction derivation unit may estimate a motion vector in the 2-dimensional tiling image obtained by tiling the 3D map information, and use the motion vector to derive the direction of the change of the relative position between the reference object and the peripheral object.

In general, processing of 2D information (image processing) is more generalized and can be introduced more inexpensively than the processing of 3D information. Accordingly, with such a configuration, the direction of the change of the relative position can be derived while suppressing an increase in costs.

### Method 1-2-1-2

Further, for example, the direction of the change of the relative position may be derived on the basis of the egocentric 3D occupancy grid map as the 3D information. In other words, when Method 1-2-1 is applied, a motion vector may be estimated from 3D map information (egocentric 3D occupancy grid map), and the relative position change direction may be derived using the motion vector as indicated on the tenth row from the top of the table shown in FIG. 9 (Method 1-2-1-2).

For example, in the information processing apparatus including the tiling direction setting unit, the tiling image generation unit, the encoding unit, and the relative position change direction derivation unit, the relative position change direction derivation unit may estimate a motion vector in the 3D map information and use the motion vector to derive the direction of the change of the relative position between the reference object and the peripheral object.

With such a configuration, since it can be derived from the egocentric 3D occupancy grid map as the 3D information (the conversion into 2D information is unnecessary), the direction of the change of the relative position can be derived more accurately.

### Method 1-2-2

Further, the direction of the change of the relative position between the reference object and the peripheral object may be derived on the basis of position information of the reference object. In other words, when Method 1-2 is applied, the direction of the change of the relative position may be derived on the basis of the position information as indicated on the eleventh row from the top of the table shown in FIG. 9 (Method 1-2-2).

For example, the information processing apparatus including the tiling direction setting unit, the tiling image generation unit, the encoding unit, and the relative position change direction derivation unit may further include a position information acquisition unit which acquires position information of the reference object, and the relative position change direction derivation unit may derive the direction of the change of the relative position between the reference object and the peripheral object on the basis of the position information.

When the change of the relative position between the reference object and the peripheral object is based only on the movement of the reference object, that is, the position or shape of the peripheral object does not change, the direction of the change of the relative position can be derived from the position information of the reference object. Then, as in the examples shown in FIGS. 11 to 13, the direction of the change of the relative position can be easily derived by merely obtaining the positional difference of the reference object between the frames.

It should be noted that the position information may be any information as long as it is information that indicates the position of the reference object. For example, the position information may be information indicating an absolute position (e.g., latitude/longitude, coordinates in a coordinate system set with respect to a predetermined 3-dimensional space, and/or the like) of the reference object, or may be information indicating a relative position of the reference object with respect to the peripheral object and/or the like.

### Method 1-2-2-1

Alternatively, the position information may be information indicating a current position (absolute position or relative position) of the reference object. In other words, when Method 1-2-2 is applied, the position information may be detected, and the relative position change direction may be derived on the basis of a change in the position information as indicated on the twelfth row from the top of the table shown in FIG. 9 (Method 1-2-2-1).

For example, in the information processing apparatus including the tiling direction setting unit, the tiling image generation unit, the encoding unit, the relative position change direction derivation unit, and the position information acquisition unit, the position information acquisition unit may detect the position information of the reference object obtained currently, and the relative position change direction derivation unit may derive the direction of the change of the relative position between the reference object and the peripheral object on the basis of the detected position information.

In other words, the position information acquisition unit may include a sensor or the like that detects the position of the reference object and detect the current position using that sensor. With such a configuration, the direction of the change of the relative position can be easily derived on the basis of the detected position information obtained at each clock time.

The sensor may be any sensor. For example, a GPS (Global Positioning System) receiver which receives GPS signals and specifies a position on the basis of the GPS signals, or the like may be used, or a ranging sensor which detects a relative position of the reference object with respect to the peripheral object may be used.

It should be noted that the position information may alternatively be generated in another apparatus. In that case, the position information acquisition unit may acquire the position information generated in that apparatus by performing communication with that apparatus, or the like. Alternatively, the position information may be generated in the reference object (apparatus), or may be generated in an apparatus other than the reference object.

### Method 1-2-2-2

Alternatively, the position information may be path planning information indicating a predetermined travel route of the reference object. In other words, when Method 1-2-2 is applied, the relative position change direction may be derived on the basis of the path planning information as indicated on the thirteenth row from the top of the table shown in FIG. 9 (Method 1-2-2-2).

For example, in the information processing apparatus including the tiling direction setting unit, the tiling image generation unit, the encoding unit, the relative position change direction derivation unit, and the position information acquisition unit, the position information acquisition unit may acquire, as the position information, path planning information indicating a predetermined travel route of the reference object, and the relative position change direction derivation unit may derive the direction of the change of the relative position between the reference object and the peripheral object on the basis of the path planning information.

Since the path planning information indicates the travel route of the reference object, the relative position change direction derivation unit can easily derive the direction of the change of the relative position on the basis of the path planning information. The position information acquisition unit may acquire the path planning information at an arbitrary timing. For example, the path planning information may be stored in advance in a memory provided in the position information acquisition unit, or the like.

### Method 1-2-3

Further, Method 1-2-1 and Method 1-2-2 described above may be applied in combination. In other words, the direction of the change of the relative position between the reference object and the peripheral object may be derived on the basis of both the 3D map information (egocentric 3D occupancy grid map or tiling image thereof) and the position information of the reference object. That is, when Method 1-2 is applied, the direction of the change of the relative position may be derived on the basis of the 3D map information and the position information as indicated on the fourteenth row from the top of the table shown in FIG. 9 (Method 1-2-3).

For example, the information processing apparatus including the tiling direction setting unit, the tiling image generation unit, the encoding unit, and the relative position change direction derivation unit may further include a position information acquisition unit which acquires position information of the reference object, and the relative position change direction derivation unit may derive the direction of the change of the relative position between the reference object and the peripheral object on the basis of the 3D map information and the position information.

The way of combining is arbitrary. A more-favorable one of the directions of the change of the relative position that have been derived on the basis of the respective pieces of information may be selected, or one direction may be derived by combining the respective directions.

### Method 1-3

Further, when Method 1 is applied, the tiling direction may be controlled periodically as indicated on the fifteenth row from the top of the table shown in FIG. 9 (Method 1-3).

For example, in the information processing apparatus including the tiling direction setting unit, the tiling image generation unit, and the encoding unit, the tiling direction setting unit may set the tiling direction at a predetermined timing. The timing may be cyclic (at predetermined intervals).

With such a configuration, the information processing apparatus can set the tiling direction on the basis of the (dynamic) relative position between the reference object and the peripheral object, which changes along a time axis.

### Method 1-3-1

It should be noted that a length of the cycle for controlling the tiling direction is arbitrary. For example, when Method 1-3 is applied, the tiling direction may be controlled for each frame as indicated on the sixteenth row from the top of the table shown in FIG. 9 (Method 1-3-1).

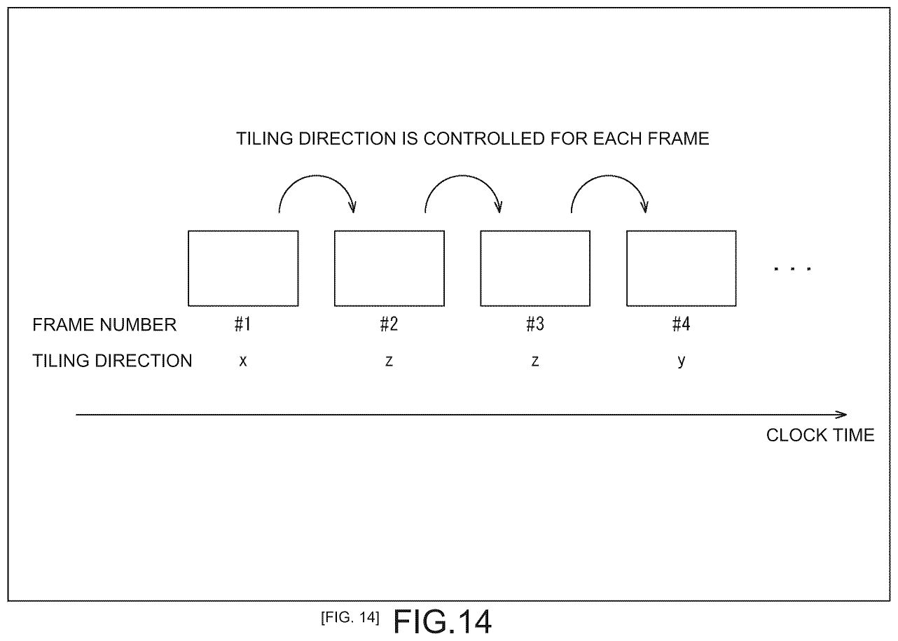

For example, in the information processing apparatus including the tiling direction setting unit, the tiling image generation unit, and the encoding unit, the tiling direction setting unit may set the tiling direction for each frame as in the example shown in FIG. 14. In the example shown in FIG. 14, the tiling direction is controlled in each frame, and the tiling direction is switched in frames #2 and #4.

With such a configuration, the information processing apparatus can control the tiling direction more promptly with respect to the direction of the change of the relative position between the reference object and the peripheral object.

### Method 1-3-2

Alternatively, the tiling direction may be controlled every plurality of frames such as every 2 frames or every 3 frames, for example. Alternatively, the tiling direction may be controlled for each GOP (Group Of Picture). In other words, when Method 1-3 is applied, the tiling direction may be controlled for each GOP as indicated on the seventeenth row from the top of the table shown in FIG. 9 (Method 1-3-2).

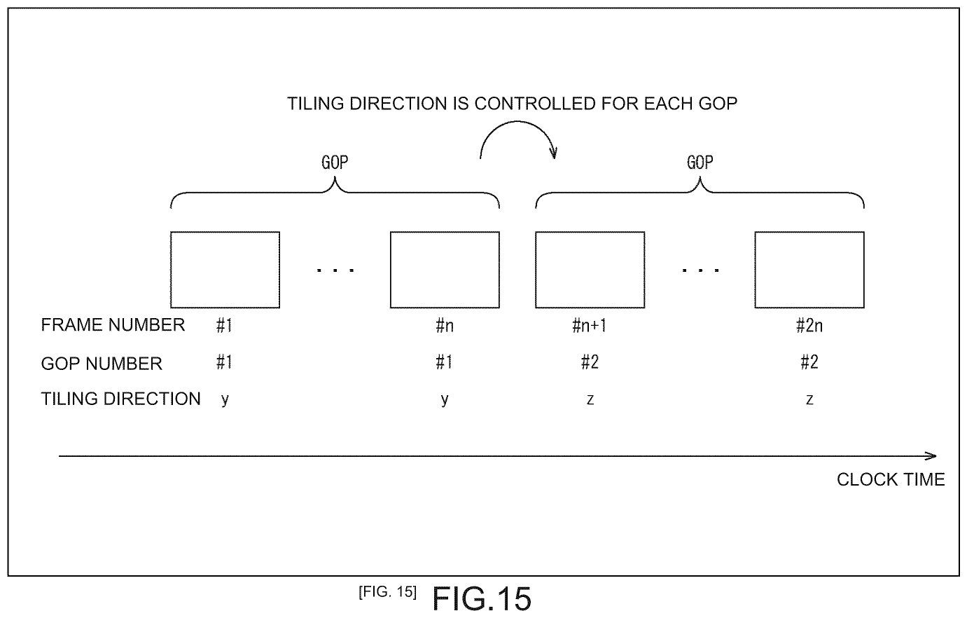

For example, in the information processing apparatus including the tiling direction setting unit, the tiling image generation unit, and the encoding unit, the tiling direction setting unit may set the tiling direction for each GOP as in the example shown in FIG. 15. In the example shown in FIG. 15, the tiling direction is controlled in each GOP. In a GOP #1, the tiling direction is set to the y-axis direction. In a GOP #2, the tiling direction is set to the z-axis direction. The tiling directions of the respective frames in the GOP are mutually the same. In other words, the tiling directions of frames #1 to #n belonging to the GOP #1 are all set to the y-axis direction. In addition, the tiling directions of frames #n+1 to #2n belonging to the GOP #1 are all set to the z-axis direction. In other words, the tiling direction can be switched only at the timing of the switch of the GOPs.

With such a configuration, the tiling direction becomes constant at least within the GOP. In other words, the tiling direction can be controlled more stably.

It should be noted that the cycle of control of the tiling direction in the case of applying Method 1-3 may be independent from the period for deriving the change of the relative position in the case of applying Method 1-1-1 or Method 1-1-2. For example, the length of the cycle of control of the tiling direction may be the same as the length of the period for deriving the change of the relative position, or may differ.

For example, in a case where Method 1-3-1 is applied and the tiling direction is controlled for each frame, Method 1-1-1 may be applied so that the tiling direction is set on the basis of the change of the relative position between two consecutive frames. Alternatively, Method 1-1-2 may be applied so that the tiling direction is set on the basis of the change of the relative position in the section of three or more consecutive frames.

Further, in a case where Method 1-3-2 is applied and the tiling direction is controlled for each GOP, Method 1-1-1 may be applied so that the tiling direction is set on the basis of the change of the relative position between two consecutive frames. Alternatively, Method 1-1-2 may be applied so that the tiling direction is set on the basis of the change of the relative position in the section of three or more consecutive frames. In that case, the length of the section may match with the length of the GOP, or may be shorter or longer than the length of the GOP.

### Method 1-4

Further, the control of the tiling direction can be performed at an arbitrary timing. For example, when Method 1 is applied, the tiling direction may be controlled irregularly as indicated on the bottom row of the table shown in FIG. 9 (Method 1-4).

For example, in the information processing apparatus including the tiling direction setting unit, the tiling image generation unit, and the encoding unit, the tiling direction setting unit may set the tiling direction when a predetermined condition is satisfied. For example, the tiling direction may be controlled only when a change of the direction of the change of the relative position is detected.

With such a configuration, the information processing apparatus can set the tiling direction at irregular timings. Moreover, control of the tiling direction at unnecessary timings can be reduced, and thus an increase of a processing load related to the control of the tiling direction can be suppressed.

### <Information Processing System>

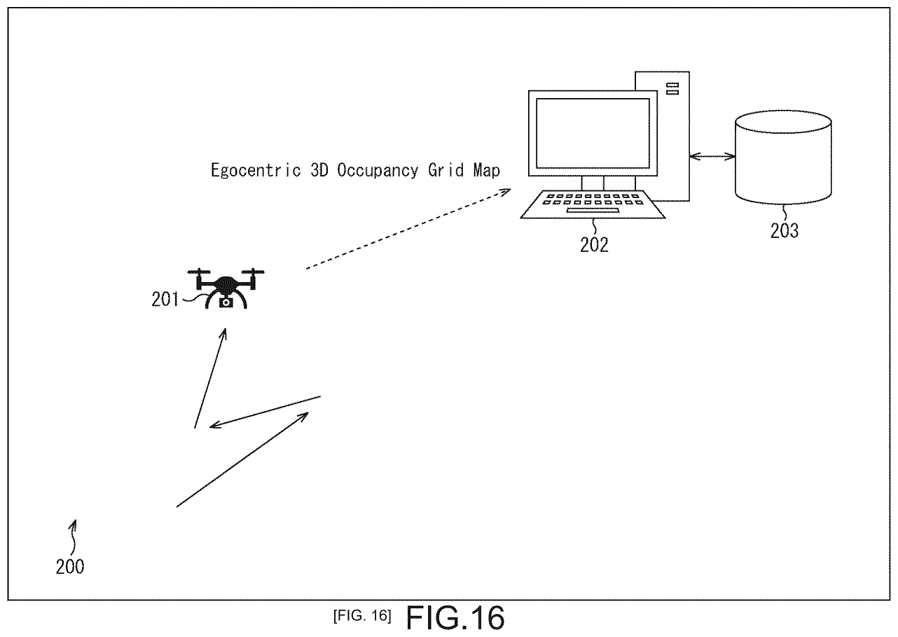

Next, application examples of the present technology will be described. FIG. 16 is a block diagram illustrating a configuration example of an information processing system as an embodiment of a system to which the present technology is applied. An information processing system 200 shown in FIG. 16 includes a movable body 201, a server 202, and a database 203. The movable body 201 is, for example, a movable device such as a so-called drone. The server 202 is an information processing apparatus different from the movable body 201, is mutually communicable with the movable body 201, and can exchange information with the movable body 201 through the communication. The database 203 includes a storage medium and is capable of storing and managing information. The database 203 is connected to the server 202 and is capable of storing and managing information supplied from the server 202. In addition, the database 203 can supply stored information to the server 202 on the basis of a request from the server 202. In such an information processing system 200, an egocentric 3D occupancy grid map is used, and the egocentric 3D occupancy grid map is encoded and decoded.

For example, the movable body 201 may generate an egocentric 3D occupancy grid map using itself as a reference object, and transmit the generated egocentric 3D occupancy grid map to the server 202 by communication. The egocentric 3D occupancy grid map may be encoded and decoded in such transmission. In other words, the movable body 201 may encode the egocentric 3D occupancy grid map and transmit it as a bit stream to the server 202. Then, the server 202 may receive and decode the bit stream to generate (restore) the egocentric 3D occupancy grid map. With such a configuration, it is possible to suppress an increase of a data transmission amount and suppress an increase of a bandwidth to be occupied in a transmission path.

Further, the server 202 may encode and decode the egocentric 3D occupancy grid map when registering the egocentric 3D occupancy grid map in the database 203. In other words, the server 202 may encode the egocentric 3D occupancy grid map and supply it as a bit stream to the database 203. Then, the database 203 may store and manage the supplied bit stream. Further, when the server 202 requests the database 203 for the egocentric 3D occupancy grid map, the database 203 may read out the requested bit stream and supply it to the server 202. The server 202 may acquire and decode the bit stream to generate (restore) the egocentric 3D occupancy grid map. With such a configuration, an increase of a storage capacity requisite for storing the egocentric 3D occupancy grid map can be suppressed.

Furthermore, the server 202 may provide the egocentric 3D occupancy grid map to the movable body 201, and the movable body 201 may control the movement of itself on the basis of the egocentric 3D occupancy grid map so that it moves autonomously. In other words, the egocentric 3D occupancy grid map may be transmitted from the server 202 to the movable body 201. The egocentric 3D occupancy grid map may be encoded and decoded in such transmission. That is, the server 202 may encode the egocentric 3D occupancy grid map and transmit it as a bit stream to the movable body 201. Then, the movable body 201 may receive and decode the bit stream to generate (restore) the egocentric 3D occupancy grid map. With such a configuration, it is possible to suppress an increase of the data transmission amount and suppress an increase of the bandwidth to be occupied in the transmission path.

The present technology described above may also be applied to such cases of the encoding of the egocentric 3D occupancy grid map.

### <Encoding Apparatus>

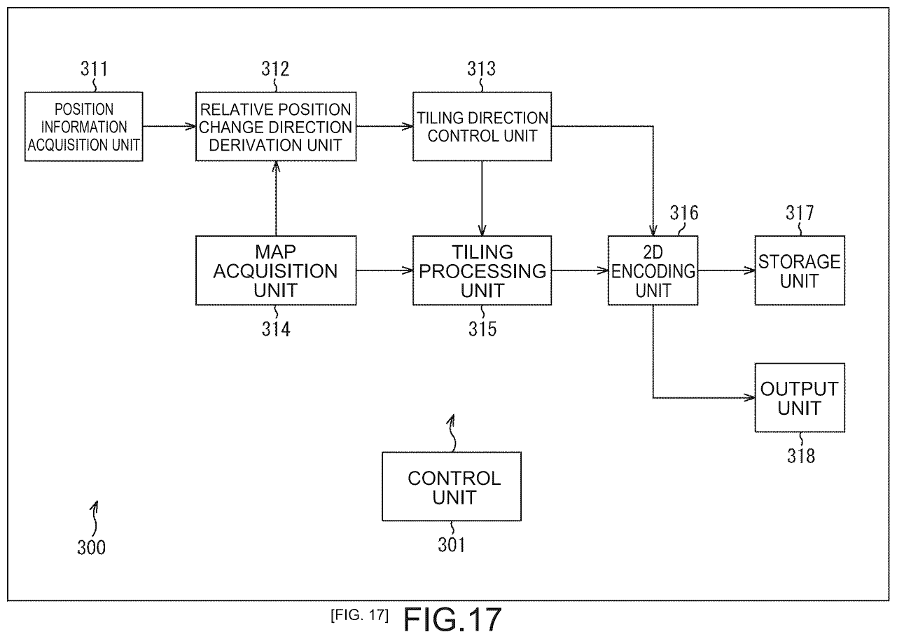

FIG. 17 is a block diagram illustrating a configuration example of an encoding apparatus as an embodiment of the information processing apparatus to which the present technology is applied. An encoding apparatus 300 shown in FIG. 17 encodes the egocentric 3D occupancy grid map by applying the present technology. In other words, the encoding apparatus 300 encodes the egocentric 3D occupancy grid map by applying one or more of the methods described above. The encoding apparatus 300 may be provided in the movable body 201 shown in FIG. 16, may be provided in the server 202, or may be provided in other apparatuses, for example.

It should be noted that FIG. 17 illustrates a main configuration including processing units, data flows, and the like, and not all of the configurations are shown in FIG. 17. In other words, in the encoding apparatus 300, there may be processing units that are not illustrated as blocks in FIG. 17, or there may be processing and data flows that are not indicated by arrows and the like in FIG. 17.

As shown in FIG. 17, the encoding apparatus 300 includes a control unit 301, a position information acquisition unit 311, a relative position change direction derivation unit 312, a tiling direction control unit 313, a map acquisition unit 314, a tiling processing unit 315, a 2D encoding unit 316, a storage unit 317, and an output unit 318.

The control unit 301 controls the respective units from the position information acquisition unit 311 to the output unit 318, to control encoding of the egocentric 3D occupancy grid map. For example, the control unit 301 may cause control of the tiling direction to be executed periodically. For example, the control unit 301 may cause the control of the tiling direction to be executed for each frame. Alternatively, the control unit 301 may cause the control of the tiling direction to be executed for each GOP. Alternatively, the control unit 301 may cause the control of the tiling direction to be executed irregularly.

The position information acquisition unit 311 performs processing related to the acquisition of position information. For example, the position information acquisition unit 311 may acquire position information by applying Method 1-2-2 or Method 1-2-3. For example, the position information acquisition unit 311 may acquire current position information of a reference object by applying Method 1-2-2-1. For example, the position information acquisition unit 311 may detect the current position information of the reference object using a sensor or the like. Alternatively, the position information acquisition unit 311 may acquire the current position information of the reference object that is supplied from another apparatus. Alternatively, the position information acquisition unit 311 may acquire, as the position information, path planning information indicating a predetermined travel route of the reference object by applying Method 1-2-2-2.

Furthermore, the position information acquisition unit 311 may supply the acquired position information to the relative position change direction derivation unit 312.

The relative position change direction derivation unit 312 performs processing related to derivation of a direction of a change of the relative position between the reference object and the peripheral object. For example, the relative position change direction derivation unit 312 may derive the direction of the change of the relative position between the reference object and the peripheral object by applying Method 1-2.

Alternatively, by applying Method 1-2-1, the relative position change direction derivation unit 312 may derive the direction of the change of the relative position between the reference object and the peripheral object on the basis of the egocentric 3D occupancy grid map. For example, the relative position change direction derivation unit 312 may acquire the egocentric 3D occupancy grid map supplied from the map acquisition unit 314. Then, the relative position change direction derivation unit 312 may derive the direction of the change of the relative position between the reference object and the peripheral object on the basis of the acquired egocentric 3D occupancy grid map.

For example, by applying Method 1-2-1-1, the relative position change direction derivation unit 312 may tile the egocentric 3D occupancy grid map to generate a tiling image, estimate a motion vector in the tiling image, and use the motion vector to derive the direction of the change of the relative position between the reference object and the peripheral object. Alternatively, by applying Method 1-2-1-2, the relative position change direction derivation unit 312 may estimate a motion vector in the egocentric 3D occupancy grid map, and use the motion vector to derive the direction of the change of the relative position between the reference object and the peripheral object.

Further, the relative position change direction derivation unit 312 may acquire position information supplied from the position information acquisition unit 311. Then, by applying Method 1-2-2, the relative position change direction derivation unit 312 may derive the direction of the change of the relative position between the reference object and the peripheral object on the basis of the acquired position information. For example, by applying Method 1-2-2-1, the relative position change direction derivation unit 312 may derive the direction of the change of the relative position between the reference object and the peripheral object on the basis of the current position information of the reference object that has been detected by the position information acquisition unit 311. Alternatively, by applying Method 1-2-2-2, the relative position change direction derivation unit 312 may derive the direction of the change of the relative position between the reference object and the peripheral object on the basis of the path planning information acquired by the position information acquisition unit 311.

Further, the relative position change direction derivation unit 312 may also acquire the egocentric 3D occupancy grid map supplied from the map acquisition unit 314. Furthermore, the relative position change direction derivation unit 312 may acquire position information supplied from the position information acquisition unit 311. Then, by applying Method 1-2-3, the relative position change direction derivation unit 312 may derive the direction of the change of the relative position between the reference object and the peripheral object on the basis of the acquired egocentric 3D occupancy grid map and position information.

The relative position change direction derivation unit 312 may supply information indicating the derived direction of the change of the relative position to the tiling direction control unit 313.

The tiling direction control unit 313 performs processing related to the control of the tiling direction. For example, by applying Method 1, the tiling direction control unit 313 may set the tiling direction in the tiling of the egocentric 3D occupancy grid map on the basis of the direction of the change of the relative position between the reference object and the peripheral object. In other words, the tiling direction control unit 313 can also be referred to as the tiling direction setting unit.

Further, the tiling direction control unit 313 may acquire information indicating the direction of the change of the relative position, which is supplied from the relative position change direction derivation unit 312. Then, by applying Method 1-2, the tiling direction control unit 313 may set the tiling direction in the tiling of the egocentric 3D occupancy grid map on the basis of that information.

At this time, by applying Method 1-1, the tiling direction control unit 313 may set the tiling direction such that a change amount of the relative position between the reference object and the peripheral object in the tiling direction becomes minimum. Alternatively, by applying Method 1-1-1, the tiling direction control unit 313 may set the tiling direction on the basis of the change of the relative position between the reference object and the peripheral object between two consecutive frames. Alternatively, by applying Method 1-1-2, the tiling direction control unit 313 may set the tiling direction on the basis of the change of the relative position between the reference object and the peripheral object in a section of three or more consecutive frames. For example, by applying Method 1-1-2-1, the tiling direction control unit 313 may set the tiling direction on the basis of the change of the relative position between the reference object and the peripheral object between a head frame and a last frame in the section. Alternatively, by applying Method 1-1-2-2, the tiling direction control unit 313 may set the tiling direction on the basis of the change of the relative position between the reference object and the peripheral object between respective frames in the section.

Furthermore, the tiling direction control unit 313 may control the tiling processing unit 315 to perform tiling using the set tiling direction.

Further, by applying Method 1, the tiling direction control unit 313 may generate tiling direction information indicating the set tiling direction, and supply the tiling direction information to the 2D encoding unit 316.

It should be noted that by applying Method 1-3, the tiling direction control unit 313 may set the tiling direction at a predetermined timing. For example, by applying Method 1-3-1, the tiling direction control unit 313 may set the tiling direction for each frame. Alternatively, by applying Method 1-3-2, the tiling direction control unit 313 may set the tiling direction for each GOP. Alternatively, by applying Method 1-4, the tiling direction control unit 313 may set the tiling direction when a predetermined condition is satisfied.

The map acquisition unit 314 performs processing related to the acquisition of the egocentric 3D occupancy grid map. For example, the map acquisition unit 314 may acquire the egocentric 3D occupancy grid map. For example, the map acquisition unit 314 may generate the egocentric 3D occupancy grid map, or may acquire the egocentric 3D occupancy grid map supplied from another apparatus.

Further, the map acquisition unit 314 may supply the acquired egocentric 3D occupancy grid map to the tiling processing unit 315. Furthermore, the map acquisition unit 314 may supply the acquired egocentric 3D occupancy grid map to the relative position change direction derivation unit 312.

The tiling processing unit 315 performs processing related to tiling. For example, the tiling processing unit 315 may acquire the egocentric 3D occupancy grid map supplied from the map acquisition unit 314. Further, the tiling processing unit 315 may tile the acquired egocentric 3D occupancy grid map under control of the tiling direction control unit 313. In other words, by applying Method 1, the tiling processing unit 315 may tile the egocentric 3D occupancy grid map in the tiling direction set by the tiling direction control unit 313 (i.e., tile a plurality of 2D images expressing 3D map information on a surface perpendicular to the set tiling direction), to thus generate a 2-dimensional tiling image. In other words, the tiling processing unit 315 can also be referred to as the tiling image generation unit. The tiling processing unit 315 may supply the generated tiling image to the 2D encoding unit 316.

The 2D encoding unit 316 performs processing related to encoding. For example, the 2D encoding unit 316 may acquire the tiling image supplied from the tiling processing unit 315. Further, by applying Method 1, the 2D encoding unit 316 may encode the tiling image as a frame image of a moving image using the moving image encoding system (for 2D information) such as AVC, HEVC, and VVC, for example, to thus generate a bit stream.

Further, the 2D encoding unit 316 may acquire the tiling direction information supplied from the tiling direction control unit 313. Furthermore, the 2D encoding unit 316 may encode the tiling direction information and store it in a bit stream obtained by encoding the tiling image.

The 2D encoding unit 316 may supply the generated bit stream to the storage unit 317. Further, the 2D encoding unit 316 may supply the generated bit stream to the output unit 38.

The storage unit 317 includes a storage medium and performs processing related to writing and reading of information to/from the storage medium. This storage medium may be any medium. For example, the storage medium may be a magnetic recording medium such as a hard disk, may be a semiconductor memory such as a RAM (Random Access Memory) and an SSD (Solid State Drive), or may be other than these. For example, the storage unit 317 may acquire a bit stream supplied from the 2D encoding unit 316. Further, the storage unit 317 may store the bit stream in the storage medium of itself. Moreover, on the basis of a request from the 2D encoding unit 316 or the like, the storage unit 317 may read out the requested bit stream from the storage medium of itself and supply it to the 2D encoding unit 316.

The output unit 318 includes a device capable of outputting information, such as an output terminal and a communication unit, and performs processing related to the output of information. A communication standard (communication method or the like) used by the communication unit is arbitrary. For example, either wired communication or wireless communication may be used, or both may be used. For example, the output unit 318 may acquire a bit stream supplied from the 2D encoding unit 316. Further, the output unit 318 may transmit the bit stream to the outside (another apparatus or the like).

With the configuration as described above, the encoding apparatus 300 can suppress lowering of the correlation between the frames and suppress lowering of the encoding efficiency in the inter-frame difference encoding. Accordingly, the encoding apparatus 300 can suppress lowering of the encoding efficiency in the encoding of the egocentric 3D occupancy grid map.

### <Flow of Encoding Processing>

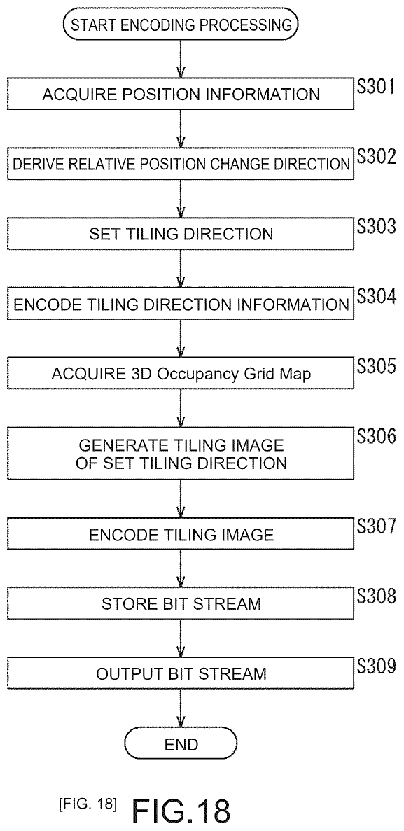

Next, an example of a flow of encoding processing executed by the encoding apparatus 300 will be described with reference to the flowchart of FIG. 18. It should be noted that in FIG. 18, a case of setting the tiling direction for each frame will be described.

Upon start of the encoding processing, the position information acquisition unit 311 acquires position information in Step S301.

In Step S302, the relative position change direction derivation unit 312 derives a direction of a change of the relative position between the reference object and the peripheral object on the basis of the position information acquired in Step S301.

In Step S303, the tiling direction control unit 313 sets a tiling direction for the tiling performed with respect to the egocentric 3D occupancy grid map on the basis of the direction of the change of the relative position between the reference object and the peripheral object, which has been derived in Step S302. Further, the tiling direction control unit 313 generates tiling direction information indicating the set tiling direction.

In Step S304, the 2D encoding unit 316 encodes the tiling direction information generated in Step S303.

In Step S305, the map acquisition unit 314 acquires the egocentric 3D occupancy grid map.

In Step S306, the tiling processing unit 315 performs tiling with respect to the egocentric 3D occupancy grid map acquired in Step S305 by applying the tiling direction set in Step S303, to thus generate a tiling image. In other words, the tiling processing unit 315 tiles a plurality of 2D images expressing the egocentric 3D occupancy grid map acquired in Step S305 on a surface perpendicular to the tiling direction set in Step S303.

In Step S307, the 2D encoding unit 316 encodes, as a frame of a moving image, the tiling image generated in Step S306 using the moving image encoding system, to thus generate a bit stream. Further, the 2D encoding unit 316 incorporates encoded data of the tiling direction information generated in Step S304 into the bit stream.

In Step S308, the storage unit 317 stores the bit stream generated in Step S306.

In Step S309, the output unit 318 outputs the bit stream generated in Step S306.

Upon ending the processing of Step S309, the encoding processing is ended. The control unit 301 causes this encoding processing to be executed for each frame.

By executing the respective processing in this manner, the encoding apparatus 300 can control the tiling direction for each frame in accordance with the direction of the change of the relative position between the reference object and the peripheral object. Accordingly, the encoding apparatus 300 can suppress lowering of the correlation between the frames and suppress lowering of the encoding efficiency in the inter-frame difference encoding. Accordingly, the encoding apparatus 300 can suppress lowering of the encoding efficiency in the encoding of the egocentric 3D occupancy grid map.

### <Flow of Encoding Processing>

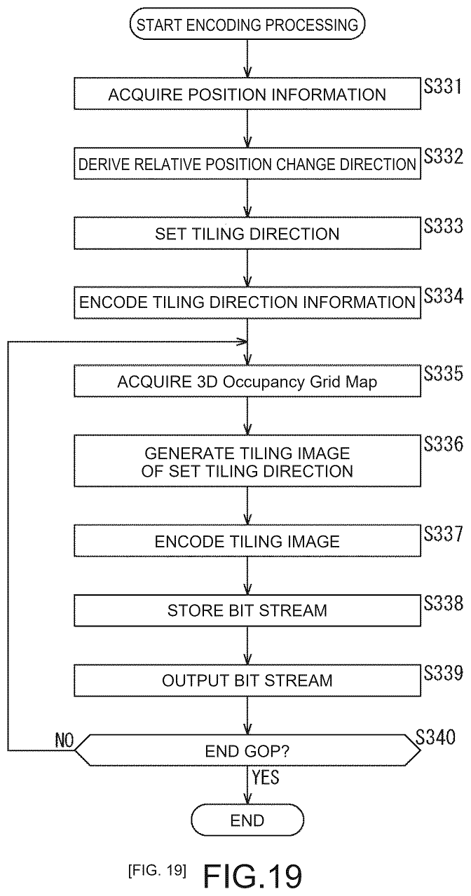

Next, an example of a flow of the encoding processing executed by the encoding apparatus 300 in a case of setting the tiling direction for each GOP will be described with reference to the flowchart of FIG. 19.

Upon start of the encoding processing, processing of Steps S331 to S339 is executed similarly to the respective processing of Steps S301 to S309 shown in FIG. 18. It should be noted that upon ending the processing of Step S339, the processing advances to Step S340.

In Step S340, the control unit 301 determines whether or not to end the GOP. When it is determined that a frame in the middle of the GOP is still being processed and there is still an unprocessed frame in the processing target GOP, and thus the GOP is not to be ended, the processing returns to Step S335, and the processing after that is executed. In other words, the processing of Steps S335 to S340 is executed with respect to each frame.

Then, when it is determined in Step S340 that all of the frames in the processing target GOP have been processed and thus the GOP is to be ended, the encoding processing is ended.

By executing the respective processing in this manner, the encoding apparatus 300 can control the tiling direction for each GOP in accordance with the direction of the change of the relative position between the reference object and the peripheral object. Accordingly, the encoding apparatus 300 can suppress lowering of the correlation between the frames and suppress lowering of the encoding efficiency in the inter-frame difference encoding. Accordingly, the encoding apparatus 300 can suppress lowering of the encoding efficiency in the encoding of the egocentric 3D occupancy grid map.

### <Decoding Apparatus>

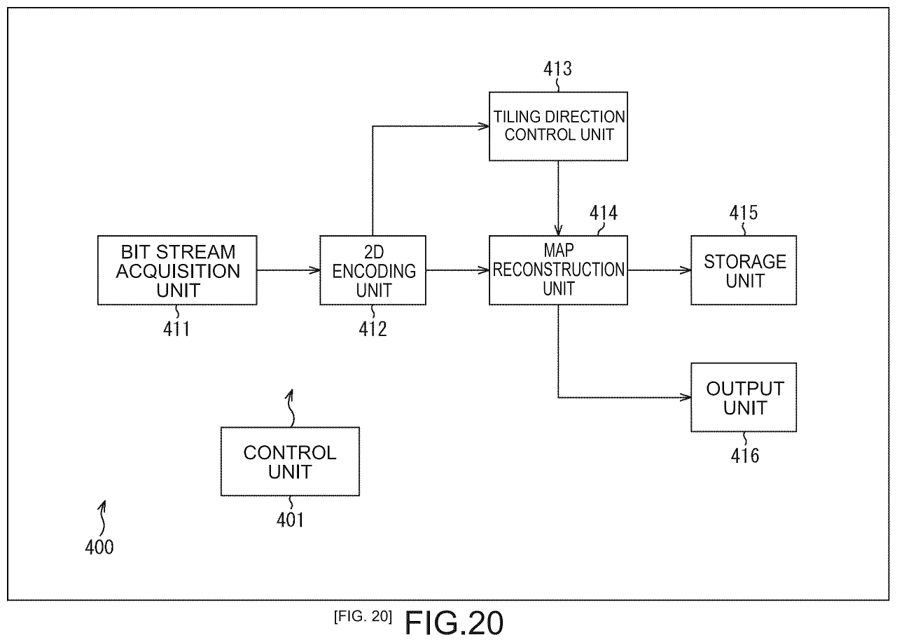

FIG. 20 is a block diagram illustrating a configuration example of a decoding apparatus as an embodiment of the information processing apparatus to which the present technology is applied. A decoding apparatus 400 shown in FIG. 20 decodes encoded data (bit stream) of an egocentric 3D occupancy grid map by applying the present technology. In other words, the decoding apparatus 400 applies one or more of the methods described above to decode a bit stream and generate (restore) a tiling image, and reconstruct the egocentric 3D occupancy grid map. The decoding apparatus 400 is a decoding apparatus corresponding to the encoding apparatus 300 and is capable of decoding the bit stream generated by the encoding apparatus 300, for example. The decoding apparatus 400 may be provided in the movable body 201 shown in FIG. 16, may be provided in the server 202, or may be provided in other apparatuses, for example.

It should be noted that FIG. 20 illustrates a main configuration including processing units, data flows, and the like, and not all of the configurations are shown in FIG. 20. In other words, in the decoding apparatus 400, there may be processing units that are not illustrated as blocks in FIG. 20, or there may be processing and data flows that are not indicated by arrows and the like in FIG. 20.

As shown in FIG. 20, the decoding apparatus 400 includes a control unit 401, a bit stream acquisition unit 411, a 2D decoding unit 412, a tiling direction control unit 413, a map reconstruction unit 414, a storage unit 415, and an output unit 416.

The control unit 401 controls the respective units from the bit stream acquisition unit 411 to the output unit 416, to control decoding of encoded data (bit stream) of (a tiling image generated using) an egocentric 3D occupancy grid map. For example, the control unit 401 may cause control of the tiling direction to be executed periodically. For example, the control unit 401 may cause the control of the tiling direction to be executed for each frame. Alternatively, the control unit 401 may cause the control of the tiling direction to be executed for each GOP. Alternatively, the control unit 401 may cause the control of the tiling direction to be executed irregularly.

The bit stream acquisition unit 411 acquires a bit stream supplied from outside the decoding apparatus 400, such as the encoding apparatus 300, for example. The bit stream acquisition unit 411 supplies the acquired bit stream to the 2D decoding unit 412.

By applying Method 1, the 2D decoding unit 412 decodes the bit stream supplied from the bit stream acquisition unit 411 using a moving image decoding system, and generates (restores) a 2-dimensional tiling image as a frame image of a moving image. The 2D decoding unit 412 supplies the generated (restored) tiling image to the map reconstruction unit 414. Further, the 2D decoding unit 412 decodes encoded data of tiling direction information included in the bit stream, to generate (restore) the tiling direction information. The 2D decoding unit 412 supplies the generated (restored) tiling direction information to the tiling direction control unit 413.

By applying Method 1, the tiling direction control unit 413 acquires the tiling direction information supplied from the 2D decoding unit 412 and sets the tiling direction to be applied to the reconstruction of the egocentric 3D occupancy grid map to the direction indicated by the tiling direction information. In other words, the tiling direction control unit 413 can also be referred to as the tiling direction setting unit. By setting the tiling direction on the basis of the tiling direction information, the tiling direction control unit 413 can set a tiling direction that is the same as the tiling direction set by the tiling direction control unit 313 of the encoding apparatus 300 with ease. The tiling direction control unit 413 controls the map reconstruction unit 414 to apply the set tiling direction to reconstruct the egocentric 3D occupancy grid map.

The map reconstruction unit 414 acquires the tiling image supplied from the 2D decoding unit 412. By applying Method 1, the map reconstruction unit 414 uses the tiling image to reconstruct the egocentric 3D occupancy grid map under control of the tiling direction control unit 313. In other words, the map reconstruction unit 414 applies the tiling direction set by the tiling direction control unit 313 to reconstruct the egocentric 3D occupancy grid map. The map reconstruction unit 414 supplies the reconstructed egocentric 3D occupancy grid map to the storage unit 415 and the output unit 416.

The storage unit 415 includes a storage medium and performs processing related to writing and reading of information to/from the storage medium. This storage medium may be any medium. For example, the storage medium may be a magnetic recording medium such as a hard disk, may be a semiconductor memory such as a RAM and an SSD, or may be other than these. For example, the storage unit 415 may acquire the egocentric 3D occupancy grid map supplied from the map reconstruction unit 414. Further, the storage unit 415 may store the egocentric 3D occupancy grid map in the storage medium of itself. Moreover, on the basis of a request from the map reconstruction unit 414 or the like, the storage unit 415 may read out the requested egocentric 3D occupancy grid map from the storage medium of itself and supply it to the map reconstruction unit 414.

The output unit 416 includes a device capable of outputting information, such as an output terminal and a communication unit, and performs processing related to the output of information. A communication standard (communication method or the like) used by the communication unit is arbitrary. For example, either wired communication or wireless communication may be used, or both may be used. For example, the output unit 416 may acquire the egocentric 3D occupancy grid map supplied from the map reconstruction unit 414. Further, the output unit 416 may transmit the egocentric 3D occupancy grid map to the outside (another apparatus or the like).

With the configuration as described above, the decoding apparatus 400 can suppress lowering of the correlation between the frames and suppress lowering of the encoding efficiency in the inter-frame difference encoding. Accordingly, the decoding apparatus 400 can suppress lowering of the encoding efficiency in the encoding of the egocentric 3D occupancy grid map.

### <Flow of Decoding Processing>

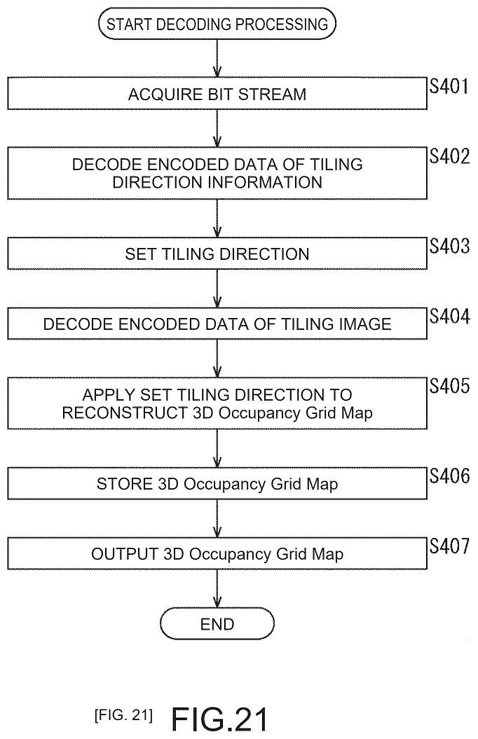

Next, an example of a flow of decoding processing executed by the decoding apparatus 400 will be described with reference to the flowchart of FIG. 21. It should be noted that in FIG. 21, the case of setting the tiling direction for each frame will be described.

Upon start of the decoding processing, the bit stream acquisition unit 411 acquires a bit stream in Step S401.

In Step S402, the 2D decoding unit 412 decodes encoded data of tiling direction information included in the bit stream acquired in Step S401, to generate (restore) the tiling direction information.

In Step S403, the tiling direction control unit 413 sets the tiling direction to a direction indicated by the tiling direction information generated (restored) in Step S402.

In Step S404, the 2D decoding unit 412 decodes encoded data of a tiling image included in the bit stream acquired in Step S401, to generate (restore) the tiling image.

In Step S405, the map reconstruction unit 414 uses the tiling direction set in Step S403 and the tiling image generated (restored) in Step S404 to reconstruct the egocentric 3D occupancy grid map.

In Step S406, the storage unit 415 stores the egocentric 3D occupancy grid map reconstructed in Step S405.

In Step S407, the output unit 416 outputs the egocentric 3D occupancy grid map reconstructed in Step S405.

Upon ending the processing of Step S407, the decoding processing is ended. The control unit 401 causes this decoding processing to be executed for each frame.

By executing the respective processing in this manner, the decoding apparatus 400 can control the tiling direction for each frame on the basis of the tiling direction information. Accordingly, the decoding apparatus 400 can suppress lowering of the correlation between the frames and suppress lowering of the encoding efficiency in the inter-frame difference encoding. Accordingly, the decoding apparatus 400 can suppress lowering of the encoding efficiency in the encoding of the egocentric 3D occupancy grid map.

### <Flow of Decoding Processing>

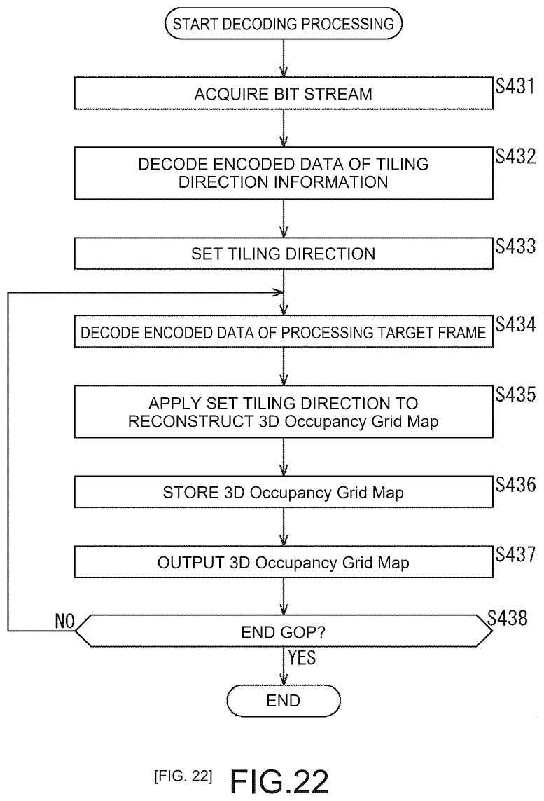

Next, an example of a flow of the decoding processing executed by the decoding apparatus 400 in the case of setting the tiling direction for each GOP will be described with reference to the flowchart of FIG. 22.

Upon start of the encoding processing, processing of Steps S431 to S437 is executed similarly to the respective processing of Steps S401 to S409 shown in FIG. 21. It should be noted that upon ending the processing of Step S437, the processing advances to Step S438.

In Step S438, the control unit 401 determines whether or not to end the GOP. When it is determined that a frame in the middle of the GOP is still being processed and there is still an unprocessed frame in the processing target GOP, and thus the GOP is not to be ended, the processing returns to Step S434, and the processing after that is executed. In other words, the processing of Steps S434 to S438 is executed with respect to each frame.

Then, when it is determined in Step S438 that all of the frames in the processing target GOP have been processed and thus the GOP is to be ended, the decoding processing is ended.

By executing the respective processing in this manner, the decoding apparatus 400 can control the tiling direction for each GOP on the basis of the tiling direction information. Accordingly, the decoding apparatus 400 can suppress lowering of the correlation between the frames and suppress lowering of the encoding efficiency in the inter-frame difference encoding. Accordingly, the decoding apparatus 400 can suppress lowering of the encoding efficiency in the encoding of the egocentric 3D occupancy grid map.

### 4. Control of Tiling Direction Based on Processing Target 2D Frame

### <Tiling Direction and Intra-Prediction>

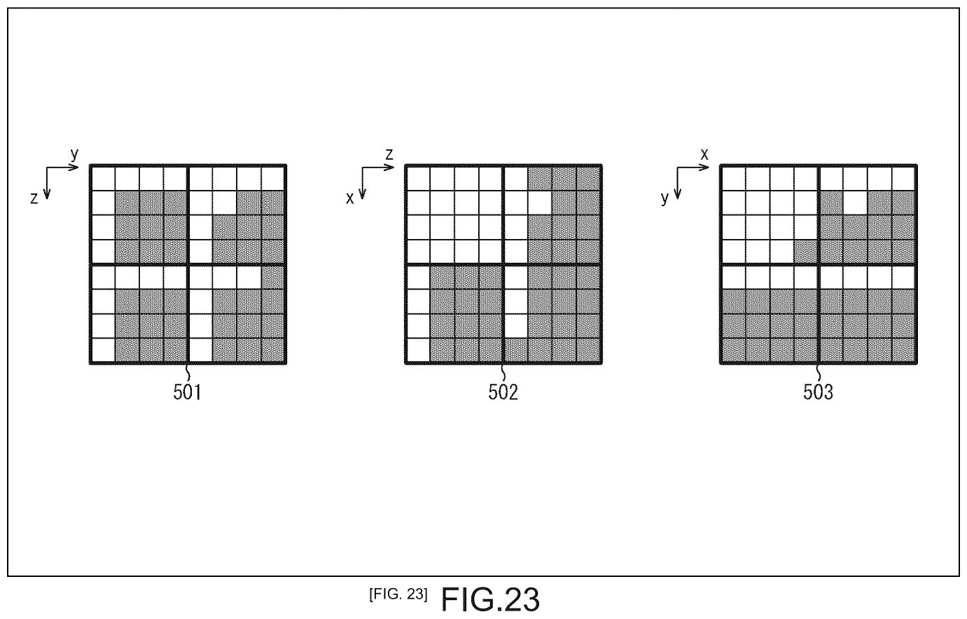

A tiling image 501 shown in FIG. 23 is a tiling image obtained by tiling the egocentric 3D occupancy grid map 101. In other words, the tiling image 501 is a tiling image generated by tiling the egocentric 3D occupancy grid map 70 (FIG. 6) while using the x-axis direction (the direction indicated by the arrow 101A) as the tiling direction.

Further, a tiling image 502 shown in FIG. 23 is a tiling image obtained by tiling the egocentric 3D occupancy grid map 102. In other words, the tiling image 502 is a tiling image generated by tiling the egocentric 3D occupancy grid map 70 (FIG. 6) while using the y-axis direction (the direction indicated by the arrow 102A) as the tiling direction.

Further, a tiling image 503 shown in FIG. 23 is a tiling image obtained by tiling the egocentric 3D occupancy grid map 103. In other words, the tiling image 503 is a tiling image generated by tiling the egocentric 3D occupancy grid map 70 (FIG. 6) while using the z-axis direction (the direction indicated by the arrow 103A) as the tiling direction.

In the tiling images 501 to 503, gray squares (grids) each indicate an occupied state. As shown in FIG. 23, in the tiling images 501 to 503, the distributions of the occupied grids differ from one another. In other words, the tiling images 501 to 503 are mutually-different images. Accordingly, the tiling images 501 to 503 have mutually-different prediction accuracies in the intra-prediction (in-screen prediction).

As described above, in the case of the method described in Patent Literature 2, the tiling direction has been fixed to one direction. Therefore, when this method is applied to the encoding of the egocentric 3D occupancy grid map, there has been a fear that the prediction accuracy in the intra-prediction will be lowered to thus lower the encoding efficiency.

### Method 2

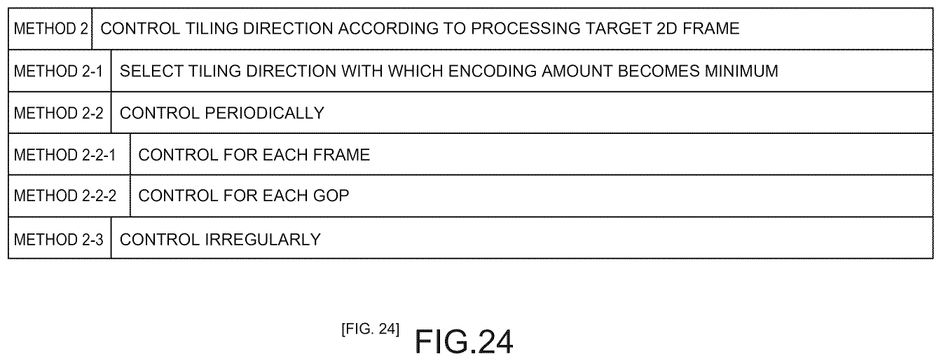

In this regard, as indicated on the top row of the table shown in FIG. 24, the tiling direction is controlled according to a processing target 2D frame (Method 2).

For example, an information processing apparatus includes: a tiling direction setting unit which sets a tiling direction of 3D map information indicating a distribution state of a peripheral object in a 3-dimensional space in a periphery of a reference object, on the basis of a 2-dimensional tiling image obtained by tiling the 3D map information; a tiling image generation unit which tiles a plurality of 2D images (the tiles 71 to 74 in the case of the example shown in FIG. 6) expressing the 3D map information on a surface perpendicular to the set tiling direction (the z direction in the case of the example shown in FIG. 6) (the xy plane in the case of the example shown in FIG. 6), to generate a tiling image (the tiling image 75 in the case of the example shown in FIG. 6); and an encoding unit which encodes the tiling image.

For example, an information processing method includes: setting a tiling direction of 3D map information indicating a distribution state of a peripheral object in a 3-dimensional space in a periphery of a reference object, on the basis of a 2-dimensional tiling image obtained by tiling the 3D map information; tiling a plurality of 2D images expressing the 3D map information on a surface perpendicular to the set tiling direction, to generate a tiling image; and encoding the tiling image.

With such a configuration, it is possible to suppress the lowering of the correlation within the frames (the prediction accuracy in the intra-prediction) as described above and suppress lowering of the encoding efficiency. Accordingly, lowering of the encoding efficiency in the encoding of the egocentric 3D occupancy grid map can be suppressed.

It should be noted that in the information processing apparatus including the tiling direction setting unit, the tiling image generation unit, and the encoding unit, the tiling direction setting unit may generate tiling direction information indicating the set tiling direction, and the encoding unit may encode the tiling direction information. With such a configuration, the information processing apparatus that decodes encoded data of a tiling image can easily grasp the tiling direction on the basis of the tiling direction information. In other words, the information processing apparatus can more easily and correctly reconstruct the egocentric 3D occupancy grid map.

For example, an information processing apparatus includes: a decoding unit which decodes a bit stream and generates a 2-dimensional tiling image and tiling direction information; a tiling direction setting unit which sets a tiling direction on the basis of the tiling direction information; and a map reconstruction unit which applies the set tiling direction to reconstruct 3D map information (egocentric 3D occupancy grid map) from the tiling image. It should be noted that the 3D map information is 3-dimensional map information indicating a distribution state of a peripheral object in a 3-dimensional space in a periphery of a reference object. In addition, the tiling image is information generated by tiling the 3D map information.

For example, an information processing method includes: decoding a bit stream and generating a 2-dimensional tiling image and tiling direction information; setting a tiling direction on the basis of the tiling direction information; and applying the set tiling direction to reconstruct 3D map information (egocentric 3D occupancy grid map) from the tiling image. It should be noted that the 3D map information is 3-dimensional map information indicating a distribution state of a peripheral object in a 3-dimensional space in a periphery of a reference object. In addition, the tiling image is information generated by tiling the 3D map information.

With such a configuration, the egocentric 3D occupancy grid map can be correctly reconstructed with ease. Accordingly, lowering of the encoding efficiency in the encoding of the egocentric 3D occupancy grid map can be suppressed.

### Method 2-1

When this Method 2 is applied, the tiling direction may be set such that an encoding amount of the processing target 2D frame becomes minimum as indicated on the second row from the top of the table shown in FIG. 24 (Method 2-1).

For example, in the information processing apparatus including the tiling direction setting unit, the tiling image generation unit, and the encoding unit, the tiling direction setting unit may set the tiling direction such that an encoding amount of the tiling image becomes minimum.

For example, the tiling direction setting unit derives an encoding amount for each of the tiling images 501 to 503 shown in FIG. 23, and selects a tiling direction of the tiling image having the smallest encoding amount among the images. With such a configuration, it is possible to suppress lowering of the encoding efficiency. Accordingly, lowering of the encoding efficiency in the encoding of the egocentric 3D occupancy grid map can be suppressed.

### Method 2-2

Further, when Method 2 is applied, the tiling direction may be controlled periodically as indicated on the third row from the top of the table shown in FIG. 24 (Method 2-2).

For example, in the information processing apparatus including the tiling direction setting unit, the tiling image generation unit, and the encoding unit, the tiling direction setting unit may set the tiling direction at a predetermined timing. The timing may be cyclic (at predetermined intervals).

With such a configuration, the information processing apparatus can set the tiling direction on the basis of the (dynamic) tiling image of each 2D frame, which changes along the time axis.

### Method 2-2-1

It should be noted that the length of the cycle for controlling the tiling direction is arbitrary. For example, when Method 2-2 is applied, the tiling direction may be controlled for each frame as indicated on the fourth row from the top of the table shown in FIG. 24 (Method 2-2-1).

For example, in the information processing apparatus including the tiling direction setting unit, the tiling image generation unit, and the encoding unit, the tiling direction setting unit may set the tiling direction for each frame as in the example shown in FIG. 14.

With such a configuration, the information processing apparatus can control the tiling direction more promptly with respect to the tiling image of each 2D frame.

### Method 2-2-2

Alternatively, the tiling direction may be controlled every plurality of frames such as every 2 frames or every 3 frames, for example. Alternatively, the tiling direction may be controlled for each GOP (Group Of Picture). In other words, when Method 2-2 is applied, the tiling direction may be controlled for each GOP as indicated on the fifth row from the top of the table shown in FIG. 24 (Method 2-2-2).

For example, in the information processing apparatus including the tiling direction setting unit, the tiling image generation unit, and the encoding unit, the tiling direction setting unit may set the tiling direction for each GOP as in the example shown in FIG. 15.

With such a configuration, the tiling direction becomes constant at least within the GOP. In other words, the tiling direction can be controlled more stably.

### Method 2-3

Further, the control of the tiling direction can be performed at an arbitrary timing. For example, when Method 2 is applied, the tiling direction may be controlled irregularly as indicated on the bottom row of the table shown in FIG. 24 (Method 2-3).

For example, in the information processing apparatus including the tiling direction setting unit, the tiling image generation unit, and the encoding unit, the tiling direction setting unit may set the tiling direction when a predetermined condition is satisfied.

With such a configuration, the information processing apparatus can set the tiling direction at irregular timings. Moreover, control of the tiling direction at unnecessary timings can be reduced, and thus an increase of a processing load related to the control of the tiling direction can be suppressed.

### <Encoding Apparatus>

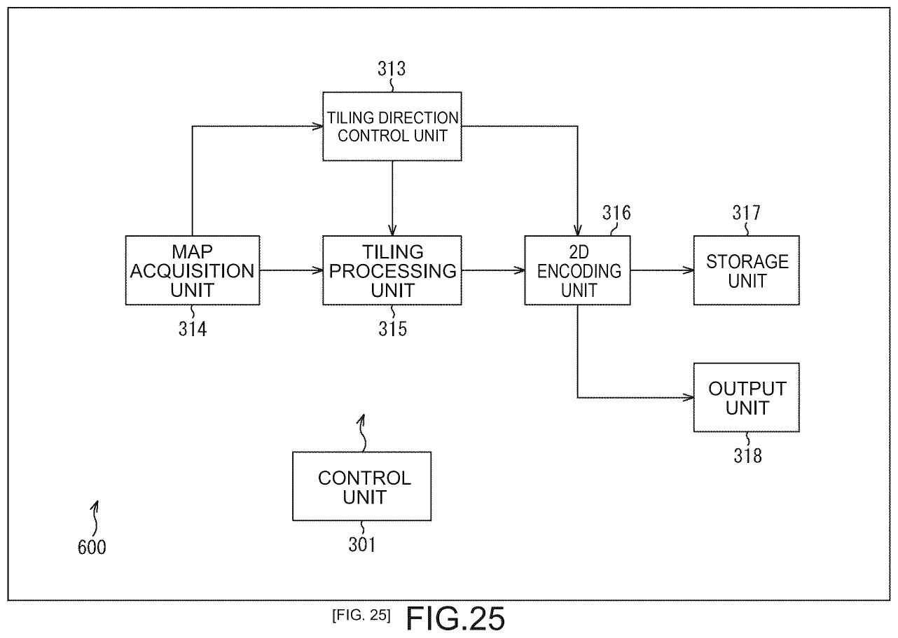

Similar to the case of Method 1, the case of this Method 2 can also be applied to the information processing system 200 shown in FIG. 16, for example. FIG. 25 is a block diagram illustrating a configuration example of the encoding apparatus as an embodiment of the information processing apparatus to which the present technology in the case of Method 2 is applied. An encoding apparatus 600 shown in FIG. 25 encodes the egocentric 3D occupancy grid map by applying the present technology. In other words, the encoding apparatus 600 encodes the egocentric 3D occupancy grid map by applying one or more of the methods described above. The encoding apparatus 600 may be provided in the movable body 201 shown in FIG. 16, may be provided in the server 202, or may be provided in other apparatuses, for example.

It should be noted that FIG. 25 illustrates a main configuration including processing units, data flows, and the like, and not all of the configurations are shown in FIG. 25. In other words, in the encoding apparatus 600, there may be processing units that are not illustrated as blocks in FIG. 25, or there may be processing and data flows that are not indicated by arrows and the like in FIG. 25.

As shown in FIG. 25, the encoding apparatus 600 includes the control unit 301, the tiling direction control unit 313, the map acquisition unit 314, the tiling processing unit 315, the 2D encoding unit 316, the storage unit 317, and the output unit 318.

In this case, the control unit 301 controls the respective units from the tiling direction control unit 313 to the output unit 318, to control encoding of the egocentric 3D occupancy grid map.

The map acquisition unit 314 to the output unit 318 basically perform processing similar to that of the case of the encoding apparatus 300 (FIG. 17). It should be noted that the map acquisition unit 314 supplies the acquired egocentric 3D occupancy grid map to the tiling direction control unit 313.

The tiling direction control unit 313 acquires the egocentric 3D occupancy grid map supplied from the map acquisition unit 314. The tiling direction control unit 313 tiles the acquired egocentric 3D occupancy grid map while each of the candidate directions is set as the tiling direction, to thus generate respective tiling images. Then, by applying Method 2, the tiling direction control unit 313 sets the tiling direction of the egocentric 3D occupancy grid map on the basis of those tiling images.

For example, by applying Method 2-1, the tiling direction control unit 313 may set the tiling direction of the egocentric 3D occupancy grid map such that the encoding amount of the tiling image becomes minimum on the basis of those tiling images.

The tiling direction control unit 313 controls the tiling processing unit 315 to perform tiling using the set tiling direction. Further, by applying Method 2, the tiling direction control unit 313 generates tiling direction information indicating the set tiling direction and supplies the tiling direction information to the 2D encoding unit 316.

It should be noted that by applying Method 2-2, the tiling direction control unit 313 may set the tiling direction at a predetermined timing. For example, by applying Method 2-2-1, the tiling direction control unit 313 may set the tiling direction for each frame. Alternatively, by applying Method 2-2-2, the tiling direction control unit 313 may set the tiling direction for each GOP. Alternatively, by applying Method 2-3, the tiling direction control unit 313 may set the tiling direction when a predetermined condition is satisfied.

With the configuration as described above, the encoding apparatus 600 can suppress lowering of the correlation within the frames (the prediction accuracy in the intra-prediction) and suppress lowering of the encoding efficiency. Accordingly, the encoding apparatus 600 can suppress lowering of the encoding efficiency in the encoding of the egocentric 3D occupancy grid map.

### <Flow of Encoding Processing>

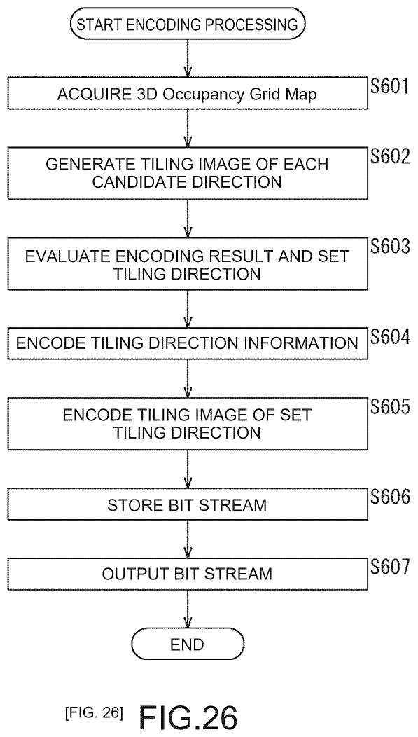

Next, an example of a flow of the encoding processing executed by the encoding apparatus 600 will be described with reference to the flowchart of FIG. 26. It should be noted that in FIG. 26, the case of setting the tiling direction for each frame will be described.

Upon start of the encoding processing, the map acquisition unit 314 acquires an egocentric 3D occupancy grid map in Step S601.

In Step S602, the tiling direction control unit 313 tiles the egocentric 3D occupancy grid map acquired in Step S601 in each of the candidate directions of the tiling direction, to thus generate respective tiling images.

In Step S603, the tiling direction control unit 313 evaluates encoding results (e.g., encoding amounts) of the respective tiling images generated in Step S602, and sets the tiling direction on the basis of that evaluation (selects an optimal direction from the candidates). Further, the tiling direction control unit 313 generates tiling direction information indicating the set tiling direction.

In Step S604, the 2D encoding unit 316 encodes the tiling direction information generated in Step S603.

In Step S605, the tiling processing unit 315 performs tiling with respect to the egocentric 3D occupancy grid map acquired in Step S601 by applying the tiling direction set in Step S603, to thus generate a tiling image. In other words, the tiling processing unit 315 tiles a plurality of 2D images expressing the egocentric 3D occupancy grid map acquired in Step S601 on a surface perpendicular to the tiling direction set in Step S603. Then, the 2D encoding unit 316 encodes, as a frame of a moving image, the tiling image using the moving image encoding system, to generate a bit stream. Furthermore, the 2D encoding unit 316 incorporates the encoded data of the tiling direction information generated in Step S604 into the bit stream.

In Step S606, the storage unit 317 stores the bit stream generated in Step S605.

In Step S607, the output unit 318 outputs the bit stream generated in Step S605.

Upon ending the processing of Step S607, the encoding processing is ended. The control unit 301 causes this encoding processing to be executed for each frame.

By executing the respective processing in this manner, the encoding apparatus 600 can control the tiling direction for each frame in accordance with the processing target 2D frame. Accordingly, the encoding apparatus 600 can suppress lowering of the correlation within the frames (the prediction accuracy in the intra-prediction) and suppress lowering of the encoding efficiency. Accordingly, the encoding apparatus 600 can suppress lowering of the encoding efficiency in the encoding of the egocentric 3D occupancy grid map.

### <Flow of Encoding Processing>

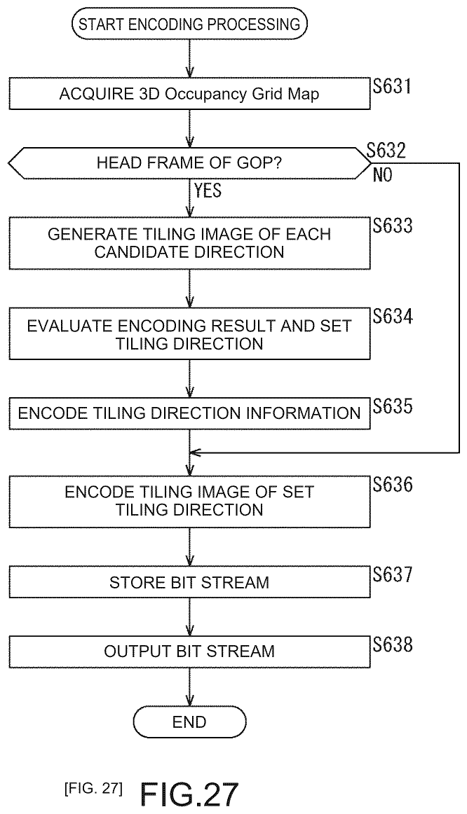

Next, an example of a flow of the encoding processing executed by the encoding apparatus 600 in the case of setting the tiling direction for each GOP will be described with reference to the flowchart of FIG. 27.

Upon start of the encoding processing, the map acquisition unit 314 acquires an egocentric 3D occupancy grid map in Step S631.

In Step S632, the control unit 301 determines whether or not the processing target frame is a head frame of a GOP. When determined that the processing target frame is the head frame of the GOP, the processing advances to Step S633.

In Step S633, the tiling direction control unit 313 tiles the egocentric 3D occupancy grid map acquired in Step S631 in each of the candidate directions of the tiling direction, to thus generate respective tiling images.

In Step S634, the tiling direction control unit 313 evaluates encoding results (e.g., encoding amounts) of the respective tiling images generated in Step S633, and sets the tiling direction on the basis of that evaluation (selects an optimal direction from the candidates). Further, the tiling direction control unit 313 generates tiling direction information indicating the set tiling direction.

In Step S635, the 2D encoding unit 316 encodes the tiling direction information generated in Step S634.

Upon ending the processing of Step S635, the processing advances to Step S636. Further, when it is determined in Step S632 that the processing target frame is not the head frame of the GOP, the processing advances to Step S636. In other words, the respective processing of Steps S633 to S635 (i.e., the setting of the tiling direction) is executed only with respect to the head frame of the GOP.

In Step S636, the tiling processing unit 315 performs tiling with respect to the egocentric 3D occupancy grid map acquired in Step S631 by applying the tiling direction set in Step S634, to thus generate a tiling image. In other words, the tiling processing unit 315 tiles a plurality of 2D images expressing the egocentric 3D occupancy grid map acquired in Step S631 on a surface perpendicular to the tiling direction set in Step S634. Then, the 2D encoding unit 316 encodes, as a frame of a moving image, the tiling image using the moving image encoding system, to generate a bit stream. Furthermore, the 2D encoding unit 316 incorporates the encoded data of the tiling direction information generated in Step S635 into the bit stream.

In Step S637, the storage unit 317 stores the bit stream generated in Step S636.

In Step S638, the output unit 318 outputs the bit stream generated in Step S636.

Upon ending the processing of Step S638, the encoding processing is ended. The control unit 301 causes this encoding processing to be executed for each frame.

By executing the respective processing in this manner, the encoding apparatus 600 can control the tiling direction for each GOP in accordance with the processing target 2D frame. Accordingly, the encoding apparatus 600 can suppress lowering of the correlation within the frames (the prediction accuracy in the intra-prediction) and suppress lowering of the encoding efficiency. Accordingly, the encoding apparatus 600 can suppress lowering of the encoding efficiency in the encoding of the egocentric 3D occupancy grid map.

It should be noted that the decoding apparatus and decoding processing in the case where Method 2 is applied are similar to those of the case where Method 1 is applied (the descriptions above can be applied), so descriptions thereof will be omitted.

### 5. Notes

### <Combination>

The respective methods described above may be applied in combination. For example, Method 1 and Method 2 described above may be applied in combination. In other words, the tiling direction may be controlled according to the relative position change direction and the processing target 2D frame. In that case, the combination method may be any method. For example, the encoding amount may be compared between the case where the tiling direction is obtained by Method 1 and the case where the tiling direction is obtained by Method 2, and a smaller one of the encoding amounts may be selected. Further, the tiling direction may be set by applying Method 1 when the relative position changes, and the tiling direction may be set by applying Method 2 when the relative position does not change.

Furthermore, the respective methods described above may be applied in combination with other methods not described above.

### <Computer>

The series of processing described above can be executed by hardware or can be executed by software. When the series of processing is executed by software, a program configuring the software is installed in a computer. Herein, the computer includes a computer incorporated into dedicated hardware, a computer such as a general-purpose personal computer for example that is capable of installing various programs therein to execute various functions, and the like.

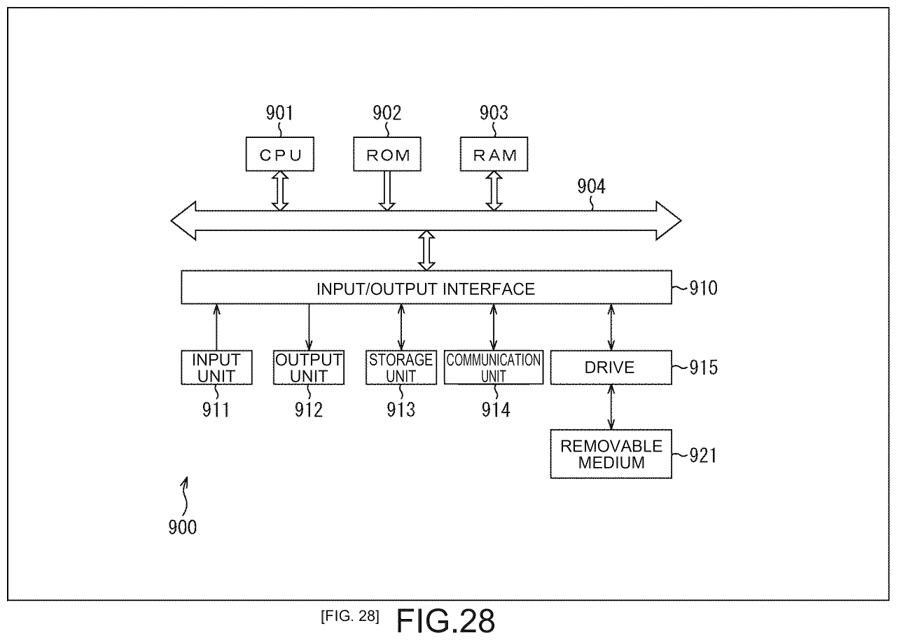

FIG. 28 is a block diagram showing a hardware configuration example of a computer that executes the series of processing described above by a program.

In a computer 900 shown in FIG. 28, a CPU (Central Processing Unit) 901, a ROM (Read Only Memory) 902, and a RAM (Random Access Memory) 903 are mutually connected via a bus 904.

An input/output interface 910 is also connected to the bus 904. Connected to the input/output interface 910 are an input unit 911, an output unit 912, a storage unit 913, a communication unit 914, and a drive 915.

The input unit 911 is constituted of, for example, a keyboard, a mouse, a microphone, a touch panel, an input terminal, and the like. The output unit 912 is constituted of, for example, a display, a speaker, an output terminal, and the like. The storage unit 913 is constituted of, for example, a hard disk, a RAM disk, a nonvolatile memory, and the like. The communication unit 914 is constituted of, for example, a network interface. The drive 915 drives a removable medium 921 such as a magnetic disc, an optical disc, a magneto optical disc, or a semiconductor memory.

In the computer configured as described above, the CPU 901 loads a program stored in the storage unit 913 into the RAM 903 via the input/output interface 910 and the bus 904 and executes it, to carry out the series of processing described above, for example. Data required for the CPU 901 to execute various types of processing, and the like are also stored in the RAM 903 as appropriate.

The program executed by the computer can be applied by being recorded onto the removable medium 921 as a package medium or the like, for example. In that case, the program can be installed in the storage unit 913 via the input/output interface 910 by loading the removable medium 921 into the drive 915.

Further, this program can also be provided via wired or wireless transmission media such as a local area network, the Internet, and digital satellite broadcasting. In that case, the program can be received by the communication unit 914 to be installed in the storage unit 913.

Alternatively, this program can be installed in advance in the ROM 902 or the storage unit 913.

### <Application Target of Present Technology>

The present technology can be applied to arbitrary configurations. For example, the present technology may be applied to various electronic apparatuses.

Moreover, for example, the present technology can be executed as a partial configuration of an apparatus, such as a processor as a system LSI (Large Scale Integration) or the like (e.g., video processor), a module that uses a plurality of processors and the like (e.g., video module), a unit that uses a plurality of modules and the like (e.g., video unit), or a set obtained by adding other functions to the unit (e.g., video set).

Further, for example, the present technology can also be applied to a network system constituted of a plurality of apparatuses. For example, the present technology may be executed as cloud computing in which a plurality of apparatuses share and cooperate to process via a network. For example, the present technology may be executed in, for example, a cloud service that provides a service related to images (moving images) to an arbitrary terminal such as a computer, an AV (Audio Visual) apparatus, a mobile information processing terminal, and an IoT (Internet of Things) device.

It should be noted that in the present specification, the system refers to an aggregation of a plurality of constituent elements (apparatuses, modules (components), and the like), and whether or not all of the constituent elements are within the same housing is irrelevant. Accordingly, a plurality of apparatuses that are housed in separate housings and are connected via a network and a single apparatus in which a plurality of modules are housed in a single housing are both systems.

<Fields/Uses to which Present Technology can Be Applied>

The systems, apparatuses, processing units, and the like to which the present technology is applied can be used in arbitrary fields of, for example, traffic, medical care, crime prevention, agriculture, livestock business, mining, beauty care, industrial plants, home electrical appliance, weather, natural surveillance, and the like. In addition, uses thereof are also arbitrary.

### <Others>

It should be noted that “flag” used in the present specification is information for identifying a plurality of states and includes not only information used when identifying two states of true (1) and false (0) but also information with which three or more states can be identified. Accordingly, values that this “flag” may take may be, for example, binary as in 1/0 or ternary or more. In other words, a bit count configuring this “flag” is arbitrary and may be 1 bit or a plurality of bits. Further, since identification information (including the flag) may take not only a form in which the identification information is incorporated in a bit stream but also a form in which differential information of the identification information with respect to certain information that becomes a reference is incorporated in a bit stream, in the present specification, the “flag” or “identification information” includes not only that information but also differential information with respect to information that becomes a reference.

In addition, various types of information (metadata etc.) related to encoded data (bit stream) may be transmitted or recorded in any form as long as the information is associated with the encoded data. Herein, the term “associate” means enabling, when processing one of the data, the other data to be used (to be linked). In other words, the data associated with each other may be compiled as one piece of data or may each be regarded as individual data. For example, information associated with encoded data (image) may be transmitted on a transmission path different from that of the encoded data (image). Further, for example, information associated with encoded data (image) may be recorded on a recording medium different from that of the encoded data (image) (or in a different recording area in the same recording medium). It should be noted that this “associate” may be applied to not only the entire data but also a part of the data. For example, an image and information corresponding to the image may be associated with each other in an arbitrary unit including a plurality of frames, one frame, one portion in a frame, or the like.

It should be noted that in the present specification, the terms “synthesize”, “multiplex”, “add”, “integrate”, “incorporate”, “store”, “put into”, “inset”, “insert”, and the like mean compiling a plurality of objects into one, such as compiling encoded data and metadata into one piece of data, for example, and refer to one method of “associate” described above.

Further, the embodiment of the present technology is not limited to the embodiments described above and can be variously modified without departing from the gist of the present technology.

For example, the configuration described as one apparatus (or processing unit) may be divided to be configured as a plurality of apparatuses (or processing units). Conversely, the configuration described above as a plurality of apparatuses (or processing units) may collectively be configured as one apparatus (or processing unit). Furthermore, configurations other than those described above may of course be added to the configurations of the respective apparatuses (or the respective processing units). In addition, as long as configurations and operations as the entire system are substantially the same, a part of a configuration of a certain apparatus (or processing unit) may be incorporated into a configuration of another apparatus (or another processing unit).

Furthermore, for example, the program described above may be executed in an arbitrary apparatus. In that case, the apparatus only needs to have necessary functions (functional blocks etc.) so as to be capable of acquiring necessary information.

Moreover, for example, respective steps of a single flowchart may be executed by a single apparatus, or may be shared by a plurality of apparatuses to be executed. In addition, when a plurality of processing is included in a single step, the plurality of processing may be executed by a single apparatus, or may be shared by a plurality of apparatuses to be executed. In other words, the plurality of processing included in a single step can be executed as processing of a plurality of steps. Conversely, processing described as a plurality of steps can collectively be executed as a single step.

Furthermore, for example, regarding the program executed by the computer, the processing of the steps describing the program may be executed in time series in the order described in the present specification, or may be executed individually in parallel at necessary timings, such as when invoked. In other words, as long as no contradiction is caused, the processing of the respective steps may be executed in an order different from the order described above. In addition, the processing of the steps describing the program may be executed in parallel with processing of other programs, or may be executed in combination with the processing of other programs.

Further, for example, as long as no contradiction is caused, the plurality of technologies related to the present technology can each be executed independently and individually. Of course, a plurality of arbitrary present technologies can be executed in combination. For example, a part or all of the present technology described in any of the embodiments can be executed in combination with a part or all of the present technology described in the other embodiments. Moreover, a part or all of the arbitrary present technology described above can be executed in combination with other technologies not described above.

It should be noted that the present technology can also take the following configurations.
(1) An information processing apparatus, including:
   a tiling direction setting unit which sets a tiling direction of 3D map information indicating a distribution state of a peripheral object in a 3-dimensional space in a periphery of a reference object, in accordance with a direction of a change of a relative position between the reference object and the peripheral object;
   a tiling image generation unit which tiles a plurality of 2D images expressing the 3D map information on a surface perpendicular to the set tiling direction, to generate a 2-dimensional tiling image; and
   an encoding unit which encodes the tiling image.
(2) The information processing apparatus according to (1), in which
   the tiling direction setting unit sets the tiling direction such that a change amount of the relative position in the tiling direction becomes minimum.
(3) The information processing apparatus according to (2), in which
   the tiling direction setting unit sets the tiling direction on the basis of the change of the relative position between two consecutive frames.
(4) The information processing apparatus according to (2) or (3), in which
   the tiling direction setting unit sets the tiling direction on the basis of the change of the relative position in a section of three or more consecutive frames.
(5) The information processing apparatus according to (4), in which
   the tiling direction setting unit sets the tiling direction on the basis of the change of the relative position between a head frame and a last frame in the section.
(6) The information processing apparatus according to (4) or (5), in which
   the tiling direction setting unit sets the tiling direction on the basis of the change of the relative position between respective frames in the section.
(7) The information processing apparatus according to any one of (1) to (6), further including
   a relative position change direction derivation unit which derives the direction of the change of the relative position, in which
   the tiling direction setting unit sets the tiling direction in accordance with the derived direction of the change of the relative position.
(8) The information processing apparatus according to (7), in which
   the relative position change direction derivation unit derives the direction of the change of the relative position on the basis of the 3D map information.
(9) The information processing apparatus according to (8), in which
   the relative position change direction derivation unit estimates a motion vector in the tiling image and uses the motion vector to derive the direction of the change of the relative position.
(10) The information processing apparatus according to (8) or (9), in which
   the relative position change direction derivation unit estimates a motion vector in the 3D map information and uses the motion vector to derive the direction of the change of the relative position.
(11) The information processing apparatus according to any one of (7) to (10), further including
   a position information acquisition unit which acquires position information of the reference object, in which
   the relative position change direction derivation unit derives the direction of the change of the relative position on the basis of the position information.
(12) The information processing apparatus according to (11), in which
   the position information acquisition unit detects the position information of the reference object obtained currently, and
   the relative position change direction derivation unit derives the direction of the change of the relative position on the basis of the detected position information.
(13) The information processing apparatus according to (11) or (12), in which
   the position information acquisition unit acquires, as the position information, path planning information indicating a predetermined travel route of the reference object, and
   the relative position change direction derivation unit derives the direction of the change of the relative position on the basis of the path planning information.
(14) The information processing apparatus according to any one of (7) to (13), further including
   a position information acquisition unit which acquires position information of the reference object, in which
   the relative position change direction derivation unit derives the direction of the change of the relative position on the basis of the 3D map information and the position information.
(15) The information processing apparatus according to any one of (1) to (14), in which
   the tiling direction setting unit sets the tiling direction at a predetermined timing.
(16) The information processing apparatus according to (15), in which
   the tiling direction setting unit sets the tiling direction for each frame.
(17) The information processing apparatus according to (15) or (16), in which
   the tiling direction setting unit sets the tiling direction for each GOP (Group Of Picture).
(18) The information processing apparatus according to any one of (1) to (17), in which
   the tiling direction setting unit sets the tiling direction when a predetermined condition is satisfied.
(19) The information processing apparatus according to any one of (1) to (18), in which
   the tiling direction setting unit generates tiling direction information indicating the set tiling direction, and
   the encoding unit encodes the tiling direction information.
(20) An information processing method, including:
   setting a tiling direction of 3D map information indicating a distribution state of a peripheral object in a 3-dimensional space in a periphery of a reference object, in accordance with a direction of a change of a relative position between the reference object and the peripheral object;
   tiling a plurality of 2D images expressing the 3D map information on a surface perpendicular to the set tiling direction, to generate a 2-dimensional tiling image; and
   encoding the tiling image.
(21) An information processing apparatus, including:
   a tiling direction setting unit which sets a tiling direction of 3D map information indicating a distribution state of a peripheral object in a 3-dimensional space in a periphery of a reference object, on the basis of a 2-dimensional tiling image obtained by tiling the 3D map information;
   a tiling image generation unit which tiles a plurality of 2D images expressing the 3D map information on a surface perpendicular to the set tiling direction, to generate the tiling image; and
   an encoding unit which encodes the tiling image.
(22) The information processing apparatus according to (21), in which
   the tiling direction setting unit sets the tiling direction such that an encoding amount of the tiling image becomes minimum.
(23) The information processing apparatus according to (21) or (22), in which
   the tiling direction setting unit sets the tiling direction at a predetermined timing.
(24) The information processing apparatus according to (23), in which
   the tiling direction setting unit sets the tiling direction for each frame.
(25) The information processing apparatus according to (23) or (24), in which
   the tiling direction setting unit sets the tiling direction for each GOP (Group Of Picture).
(26) The information processing apparatus according to any one of (21) to (25), in which
   the tiling direction setting unit sets the tiling direction when a predetermined condition is satisfied.
(27) An information processing method, including:
   setting a tiling direction of 3D map information indicating a distribution state of a peripheral object in a 3-dimensional space in a periphery of a reference object, on the basis of a 2-dimensional tiling image obtained by tiling the 3D map information;
   tiling a plurality of 2D images expressing the 3D map information on a surface perpendicular to the set tiling direction, to generate the tiling image; and
   encoding the tiling image.
(31) An information processing apparatus, including:
   a decoding unit which decodes a bit stream and generates a 2-dimensional tiling image and tiling direction information;
   a tiling direction setting unit which sets a tiling direction on the basis of the tiling direction information; and
   a map reconstruction unit which applies the set tiling direction to reconstruct 3D map information from the tiling image, in which
   the 3D map information is 3-dimensional map information indicating a distribution state of a peripheral object in a 3-dimensional space in a periphery of a reference object, and
   the tiling image is information generated by tiling a plurality of 2D images expressing the 3D map information on a surface perpendicular to the tiling direction.
(32) An information processing method, including:
   decoding a bit stream and generating a 2-dimensional tiling image and tiling direction information;
   setting a tiling direction on the basis of the tiling direction information; and
   applying the set tiling direction to reconstruct 3D map information from the tiling image, in which
   the 3D map information is 3-dimensional map information indicating a distribution state of a peripheral object in a 3-dimensional space in a periphery of a reference object, and
   the tiling image is information generated by tiling a plurality of 2D images expressing the 3D map information on a surface perpendicular to the tiling direction.

### REFERENCE SIGNS LIST

200 information processing system
201 movable body
202 server
203 database
300 encoding apparatus
301 control unit
311 position information acquisition unit
312 relative position change direction derivation unit
313 tiling direction control unit
314 map acquisition unit
315 tiling processing unit
316 2D encoding unit
317 storage unit
318 output unit
400 decoding apparatus
401 control unit
411 bit stream acquisition unit
412 2D decoding unit
413 tiling direction control unit
414 map reconstruction unit
415 storage unit
416 output unit
600 encoding apparatus
900 computer

1. An information processing apparatus, comprising:
a tiling direction setting unit which sets a tiling direction of 3D map information indicating a distribution state of a peripheral object in a 3-dimensional space in a periphery of a reference object, in accordance with a direction of a change of a relative position between the reference object and the peripheral object;
a tiling image generation unit which tiles a plurality of 2D images expressing the 3D map information on a surface perpendicular to the set tiling direction, to generate a 2-dimensional tiling image; and
an encoding unit which encodes the tiling image.

2. The information processing apparatus according to claim 1, wherein
the tiling direction setting unit sets the tiling direction such that a change amount of the relative position in the tiling direction becomes minimum.

3. The information processing apparatus according to claim 2, wherein
the tiling direction setting unit sets the tiling direction on a basis of the change of the relative position between two consecutive frames.

4. The information processing apparatus according to claim 2, wherein
the tiling direction setting unit sets the tiling direction on a basis of the change of the relative position in a section of three or more consecutive frames.

5. The information processing apparatus according to claim 4, wherein
the tiling direction setting unit sets the tiling direction on a basis of the change of the relative position between a head frame and a last frame in the section.

6. The information processing apparatus according to claim 4, wherein
the tiling direction setting unit sets the tiling direction on a basis of the change of the relative position between respective frames in the section.

7. The information processing apparatus according to claim 1, further comprising
a relative position change direction derivation unit which derives the direction of the change of the relative position, wherein
the tiling direction setting unit sets the tiling direction in accordance with the derived direction of the change of the relative position.

8. The information processing apparatus according to claim 7, wherein
the relative position change direction derivation unit derives the direction of the change of the relative position on a basis of the 3D map information.

9. The information processing apparatus according to claim 8, wherein
the relative position change direction derivation unit estimates a motion vector in the tiling image and uses the motion vector to derive the direction of the change of the relative position.

10. The information processing apparatus according to claim 8, wherein
the relative position change direction derivation unit estimates a motion vector in the 3D map information and uses the motion vector to derive the direction of the change of the relative position.

11. The information processing apparatus according to claim 7, further comprising
a position information acquisition unit which acquires position information of the reference object, wherein
the relative position change direction derivation unit derives the direction of the change of the relative position on a basis of the position information.

12. The information processing apparatus according to claim 11, wherein
the position information acquisition unit detects the position information of the reference object obtained currently, and
the relative position change direction derivation unit derives the direction of the change of the relative position on a basis of the detected position information.

13. The information processing apparatus according to claim 11, wherein
the position information acquisition unit acquires, as the position information, path planning information indicating a predetermined travel route of the reference object, and
the relative position change direction derivation unit derives the direction of the change of the relative position on a basis of the path planning information.

14. The information processing apparatus according to claim 1, wherein
the tiling direction setting unit sets the tiling direction at a predetermined timing.

15. The information processing apparatus according to claim 14, wherein
the tiling direction setting unit sets the tiling direction for each frame.

16. The information processing apparatus according to claim 14, wherein
the tiling direction setting unit sets the tiling direction for each group of picture.

17. The information processing apparatus according to claim 1, wherein
the tiling direction setting unit generates tiling direction information indicating the set tiling direction, and
the encoding unit encodes the tiling direction information.

18. An information processing method, comprising:
setting a tiling direction of 3D map information indicating a distribution state of a peripheral object in a 3-dimensional space in a periphery of a reference object, in accordance with a direction of a change of a relative position between the reference object and the peripheral object;
tiling a plurality of 2D images expressing the 3D map information on a surface perpendicular to the set tiling direction, to generate a 2-dimensional tiling image; and
encoding the tiling image.

19. An information processing apparatus, comprising:
a decoding unit which decodes a bit stream and generates a 2-dimensional tiling image and tiling direction information;
a tiling direction setting unit which sets a tiling direction on a basis of the tiling direction information; and
a map reconstruction unit which applies the set tiling direction to reconstruct 3D map information from the tiling image, wherein
the 3D map information is 3-dimensional map information indicating a distribution state of a peripheral object in a 3-dimensional space in a periphery of a reference object, and
the tiling image is information generated by tiling a plurality of 2D images expressing the 3D map information on a surface perpendicular to the tiling direction.

20. An information processing method, comprising:
decoding a bit stream and generating a 2-dimensional tiling image and tiling direction information;
setting a tiling direction on a basis of the tiling direction information; and
applying the set tiling direction to reconstruct 3D map information from the tiling image, wherein
the 3D map information is 3-dimensional map information indicating a distribution state of a peripheral object in a 3-dimensional space in a periphery of a reference object, and
the tiling image is information generated by tiling a plurality of 2D images expressing the 3D map information on a surface perpendicular to the tiling direction.
